(19) United States
(12) Patent Application Publication
(10) Pub. No.: US 2026/0082326 A1
(43) Pub. Date: Mar. 19, 2026

(54) METHOD AND APPARATUS FOR RECEIVING SYNCHRONIZATION SIGNAL BY USER EQUIPMENT HAVING A WAKE-UP RECEIVER IN A WIRELESS COMMUNICATION SYSTEM

(71) Applicant: Samsung Electronics Co., Ltd., Gyeonggi-do (KR)

(72) Inventors: Seunghoon CHOI, Gyeonggi-do (KR); Hyewon YANG, Gyeonggi-do (KR); Youngrok JANG, Gyeonggi-do (KR)

(21) Appl. No.: 19/326,257

(22) Filed: Sep. 11, 2025

(30) Foreign Application Priority Data
Sep. 13, 2024 (KR) 10-2024-0125642

(51) Int. Cl. H04W 52/02; H04W 48/08

(52) U.S. Cl. CPC H04W 52/0229; H04W 48/08; H04W 52/028

(57) ABSTRACT

The disclosure relates to a 5G or 6G communication system for supporting a higher data transmission rate. In accordance with an aspect of the disclosure, a method performed by a user equipment (UE) in a wireless communication system comprises, receiving, from a base station (BS), configuration information for receiving a low-power synchronization signal (LP-SS), identifying a relation of quasi co-location (QCL) between the LP-SS and synchronization signal blocks (SSB) s based on the configuration information, wherein the SSBs are indicated by a field of SSB-PositionInBurst in a system information block 1 (SIB1), and receiving, from the BS, the LP-SS based on the identified relation of the QCL.

### CROSS-REFERENCE TO RELATED APPLICATION(S)

This application is based on and claims priority under 35 U.S.C. § 119 to Korean Patent Application No. 10-2024-0125642, filed on Sep. 13, 2024, in the Korean Intellectual Property Office, the disclosure of which is incorporated herein by reference in its entirety.

### BACKGROUND

### 1. Field

The disclosure generally relates to a wireless communication system and, more particularly, to a method and an apparatus for receiving a wake-up receiver (WUR)-dedicated synchronization signal for a user equipment (UE) in a wireless communication system.

### 2. Description of Related Art

5th generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz bands. It has been considered to implement 6th generation (6G) mobile communication technologies referred to as beyond 5G systems in terahertz (THz) bands (for example, 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access (RA) channel (2-step RACH) for simplifying RA procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

To process mobile data traffic which has recently increased exponentially, initial standards of NR access technology or 5G systems which are next-generation communication systems after long term evolution (LTE) (or evolved universal terrestrial radio access (E-UTRA)) and LTE-advanced (LTE-A) (or E-UTRA evolution) have been completed. While legacy mobile communication systems have focused on conventional voice/data communication, 5G systems aim to satisfy various services and requirements, such as the eMBB) service for improving legacy voice/data communication, the URLLC service, and the MTC service supporting massive machine-to-machine communication.

The system transmission bandwidth per single carrier of legacy LTE and LTE-A is limited to a maximum of 20 megahertz (MHz), but 5G systems aim to provide super-fast data services up to multiple Gbps by using super-broad bandwidths far wider than the same. Accordingly, 5G systems consider ultrahigh-frequency bands ranging from multiple GHz to a maximum of 100 GHz, in which it is relatively easy to secure ultrawide-bandwidth frequencies, as candidate frequencies. Additionally, it is possible to secure broad-bandwidth frequencies for 5G systems through frequency rearrangement or allocation among frequency bands ranging from hundreds of MHz to multiple GHz used in legacy mobile communication systems.

Radio waves in ultrahigh frequency bands have millimeter-level wavelengths and thus are also referred to as mmWave. However, the pathloss of radio waves in ultrahigh frequency bands increases in proportion to the frequency band, thereby reducing the coverage of the mobile communication systems.

To overcome the shortcoming of coverage reduction in ultrahigh frequency bands, a beamforming technology is applied such that the distance reached by radio waves is increased by concentrating the energy radiated by the radio waves at a specific target point by using multiple antennas. That is, signals to which the beamforming technology is applied have a smaller beam width, and radiated energy is concentrated within the smaller beam width, thereby increasing the distance reached by radio waves. The beamforming technology may be applied to each of the transmission and reception ends. In addition to the increased coverage, the beamforming technology is also advantageous in that interference is reduced in regions in directions other than the beamforming direction. Appropriate operations of the beamforming technology require a method for accurately measuring transmitted/received beams and sending feedback. The beamforming technology may be applied to a control channel or a data channel having one-to-one correspondence between a UE and a base station (BS). The beamforming technology may also be applied to a control channel and a data channel for transmitting a common signal transmitted from a BS to multiple UEs in the system, such as a synchronization signal, a physical broadcast channel (PBCH), and system information, to increase the coverage. When the beamforming technology is applied to a common signal, a beam sweeping technology is additionally applied such that the signal is transmitted after changing the beam direction, thereby ensuring that the common signal can reach a UE existing at a specific location inside the cell.

As another requirement of 5G systems, an ultra-low latency service is required such that the transmission delay between the transmission and reception ends is about 1 ms. In an attempt to reduce the transmission delay, there is a need in the art for frame structure design based on a shorter transmission time interval (TTI) than LTE and LTE-A. The TTI is the basic time unit for performing scheduling, and legacy LTE and LTE-A have a TTI of 1 ms, which corresponds to the length of one subframe. For example, the short TTI, on which 5G systems are based to meet the requirement regarding the ultra-low latency service, may be 0.5 ms, 0.25 ms, 0.125 ms, or the like, which is shorter than legacy LTE and LTE-A.

To achieve ultra-high-speed data service of up to several gigabits per second (Gbps), the 5G system may support transmission and reception of signals in an ultra-wide bandwidth of several tens to several hundreds of MHz or several GHz. Ultra-wide bandwidth signal transmission and reception may be supported through a single component carrier (CC), or through carrier aggregation (CA) technology that combines multiple CCs. When a mobile communication service provider cannot secure a frequency of sufficient bandwidth for providing ultra-high-speed data services with a single CC, the CA technology may increase the total frequency bandwidth by combining CCs each having a relatively small bandwidth size, thereby supporting ultra-high-speed data services.

5G systems are designed and developed for a variety of use cases. In addition to standby time, reliability, and availability, energy efficiency of the UE is essential in 5G systems. The UE performs charging depending on the user's usage time, such as on a weekly or daily basis, and typically consumes tens of milliwatts (mW) in an RRC_IDLE/RRC_INACTIVE state and hundreds of mW in an RRC_CONNECTED state. Designing for extended battery life may be essential for improving energy efficiency as well as improving user experience. Energy efficiency may be even more important for the UE that does not have a continuous energy source (e.g., A UE using a small rechargeable and single coin cell battery, etc.). Among 5G use cases, sensors and actuators are widely arranged for monitoring, measuring, charging, etc., and batteries are typically non-rechargeable and may require a battery life of at least several years. In addition, wearables may also include smartwatches, rings, eHealth-related devices, medical monitoring devices, etc., which are generally difficult to maintain a charge up to 1 to 2 weeks depending on the usage time.

The power consumption of a 5G UEs depends on the configured length of wake-up periods (e.g., paging cycle), and a large extended discontinuous reception (eDRX) cycle may be used to meet the battery life requirement. However, the eDRX scheme is unsuitable for low latency services because it maintains a long battery life based on high latency. For example, in a fire detection and extinguishing use case, the fire shutter may need to be closed and the sprinkler may need to be turned on by an actuator within 1 to 2 seconds from a time point at which a fire is detected by a sensor. In this case, latency may be critical, and a long eDRX cycle as before is unsuitable because the long cycle fails to meet the latency requirement.

As such, there is a need in the art for methods and devices that cure these deficiencies in the conventional art.

### SUMMARY

The disclosure has been made to address at least the above-mentioned problems and/or disadvantages and to provide at least the advantages described below.

In accordance with an aspect of the disclosure, a an apparatus and a method capable of effectively providing services in a mobile communication system are provided.

In accordance with an aspect of the disclosure, a method performed by a user equipment (UE) in a wireless communication system comprises, receiving, from a base station (BS), configuration information for receiving a low-power synchronization signal (LP-SS), identifying a relation of quasi co-location (QCL) between the LP-SS and synchronization signal blocks (SSB) s based on the configuration information, wherein the SSBs are indicated by a field of SSB-PositionInBurst in a system information block 1 (SIB1), and receiving, from the BS, the LP-SS based on the identified relation of the QCL.

In accordance with an aspect of the disclosure, a method performed by a base station (BS) in a wireless communication system, the method comprises, transmitting, to a user equipment (UE), configuration information for receiving a low-power synchronization signal (LP-SS), and transmitting, to the UE, the LP-SS based on a relation of quasi co-location (QCL) between the LP-SS and synchronization signal blocks (SSB) s, wherein the SSBs are indicated by a field of SSB-PositionInBurst in a system information block 1 (SIB1).

In accordance with an aspect of the disclosure, a user equipment (UE) comprises a transceiver, and a processor coupled to the transceiver and configured to, receive, from a base station (BS), configuration information for receiving a low-power synchronization signal (LP-SS), identify a relation of quasi co-location (QCL) between the LP-SS and synchronization signal blocks (SSB) s based on the configuration information, wherein the SSBs are indicated by a field of SSB-PositionInBurst in a system information block 1 (SIB1), and receive, from the BS, the LP-SS based on the identified relation of the QCL.

In accordance with an aspect of the disclosure, a base station (BS) comprises, a transceiver, and a processor coupled to the transceiver and configured to, transmit, to a user equipment (UE), configuration information for receiving a low-power synchronization signal (LP-SS), and transmit, to the UE, the LP-SS based on a relation of quasi co-location (QCL) between the LP-SS and synchronization signal blocks (SSB) s, wherein the SSBs are indicated by a field of SSB-PositionInBurst in a system information block 1 (SIB1).

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency resource domain in a wireless communication system according to an embodiment;

FIG. 2 illustrates a beam sweeping operation and a time domain mapping structure of a synchronization signal according to an embodiment;

FIG. 3 illustrates a flow of signals for performing an RA according to an embodiment;

FIG. 4 illustrates a flow of signals used by a UE to report UE capability information to a BS according to an embodiment;

FIG. 5 illustrates state transitions of a BS and a UE and a UE state based on a BS state, according to an embodiment;

FIG. 6 illustrates configuring a resource for transmitting or receiving a WUR-dedicated synchronization signal according to an embodiment;

FIG. 7 illustrates a quasi co-location (QCL) between a WUR-dedicated synchronization signal and a legacy synchronization signal according to an embodiment;

FIG. 8 illustrates a QCL between a WUR-dedicated synchronization signal and a legacy synchronization signal according to an embodiment;

FIG. 9 illustrates a QCL between a WUR-dedicated synchronization signal and a legacy synchronization signal according to an embodiment;

FIG. 10 illustrates a method of a UE according to an embodiment;

FIG. 11 illustrates a method of a BS according to an embodiment;

FIG. 12 illustrates a structure of a UE according to an embodiment; and

FIG. 13 illustrates a structure of a BS according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may cause the subject matter of the disclosure unclear will be omitted for the sake of clarity and conciseness.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Terms as used herein will be briefly described, and then the disclosure will be described in detail.

The terms as used herein are currently widely used general terms selected in consideration of the functions in the disclosure as much as possible, but may be different according to intentions of those skilled in the art, customs, or emergence of new technologies. In some cases, the terms as used herein are arbitrarily selected and the meanings of these terms will be described in detail in the corresponding parts of the description. Therefore, the terms as used herein should be defined based on the meanings of the terms and the contents throughout the disclosure, rather than the nominal names of the terms.

Throughout the disclosure, when a part is referred to as “including” an element, it does not exclude the existence of other elements and the part may further include other elements unless specially indicated otherwise. As used herein, such terms as “ . . . unit” and “ . . . module” refer to a unit configured to process at least one function or operation, and may be implemented as hardware, software, or a combination of hardware and software.

In the accompanying drawings, some elements may be exaggerated, omitted, or schematically illustrated. The size of each element mays not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms.

Herein, the term unit refers to a software element or a hardware element, such as a field programmable gate array (FPGA) or an application specific integrated circuit (ASIC), and the unit may perform certain functions. However, the unit does not always have a meaning limited to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. Moreover, the elements and units may be implemented to reproduce one or more central processing units (CPUs) within a device or a security multimedia card. The unit in the embodiments may include one or more processors.

As used herein, each of such phrases as “A/B”, “A or B”, “at least one of A and B”, “at least one of A or B”, “A, B, or C”, “at least one of A, B, and C”, and “at least one of A, B, or C” may include all possible combinations of the items enumerated together in a corresponding one of the phrases. Such terms as “a first,” “a second,” “the first,” and “the second” may be used to simply distinguish a corresponding element from another, and does not limit the elements in importance or order.

Herein, an operation of a main radio may be also understood as an operation of a UE including a main radio, and/or an operation of a processor included in a UE including a main radio.

An operation of a WUR may be also understood as an operation of a UE including a WUR, and/or an operation a processor included in a UE including a WUR.

Unless specifically mentioned otherwise, a main radio and/or a WUR may be used for signal/channel reception of a UE.

Turning “ON” may include both transition from an OFF state to an ON state and maintaining an ON state in the ON state.

Turning “OFF” may include both transition from an ON state to an OFF state and maintaining an OFF state in the OFF state.

The term “less than” (or less than a specific value, etc.) may be replaced with “less than or equal to”, and the term “less than or equal to” may be replaced with “less than”.

The term “exceed” (or greater than a specific value, etc.) may be replaced with “greater than or equal to”, and “greater than or equal to” may be replaced with “exceed”.

Herein, the terms “physical channel” and “signal” may be interchangeably used with the term “data” or “control signal”. For example, the term “physical downlink shared channel (PDSCH)” refers to a physical channel over which data is transmitted and may also refer to the data. That is, the expression “transmit ting a physical channel” may be construed as having the same meaning as the expression “transmitting data or a signal over a physical channel”.

Higher signaling refers to a signal transfer scheme from a BS to a terminal via a downlink (DL) data channel of a physical layer, or from a terminal to a BS via an uplink (UL) data channel of a physical layer. The higher signaling may also be understood as radio resource control (RRC) signaling or a media access control (MAC) control element (CE).

The disclosure will be described using terms used in some communication standards such as the 3rd generation partnership project (3GPP), but these are for illustrative purposes only. Embodiments of the disclosure may also be easily applied to other communication systems through modifications. The term “terminal” may refer to not only cellular phones, smartphones, IoT devices, and sensors, but also other wireless communication devices.

Herein, a BS allocates resources to terminals, and may be at least one of a gNode B, a gNB, an eNode B, an eNB, a Node B, a wireless access unit, a BS controller, and a node on a network. A terminal may include a UE, a mobile station (MS), a cellular phone, a smartphone, a computer, or a multimedia system capable of performing a communication function. Examples of the BS and the terminal are not limited to those mentioned above. Systems based on LTE, LTE-A, or NR may be described by way of example, but various embodiments of the disclosure may also be applied to other communication systems having similar technical backgrounds or channel types. The contents of the disclosure may be applied to frequency division duplex (FDD) systems, time division duplex (TDD) systems, cross division duplex (XDD) systems, and subband full duplex (SBFD) systems,

Based on determinations by those skilled in the art, various embodiments of the disclosure may also be applied to other communication systems through some modifications without significantly departing from the scope of the embodiments of the disclosure.

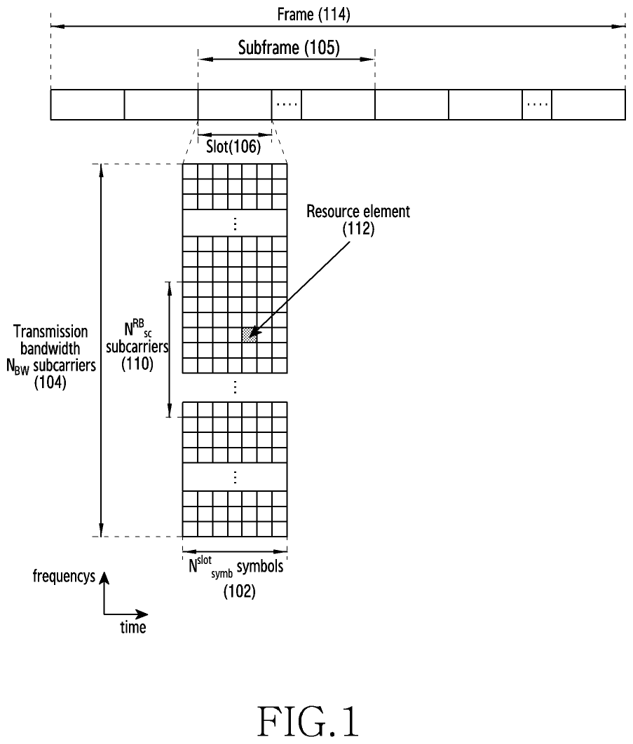

FIG. 1 illustrates a basic structure of a time-frequency resource domain in a wireless communication system according to an embodiment.

Referring to FIG. 1, a basic structure of a time-frequency resource domain which is a radio resource domain used to transmit data or control channels of a 5G system is provided.

The horizontal axis in FIG. 1 denotes the time domain, and the vertical axis denotes the frequency domain. The minimum transmission unit in the time domain of the 5G system is an orthogonal frequency division multiplexing (OFDM) symbol, a group

$${N}_{symb}^{slot}$$

symbols 102 may constitute one slot 106, and a group of

$${N}_{slot}^{subframe}$$

slots may constitute one subframe 105. The subframe's length may be 1.0 millisecond (ms), and a group of ten subframes may constitute a 10 ms frame 114. The minimum transmission unit in the frequency domain is a subcarrier, and a total of New subcarriers 104 may constitute the entire system transmission bandwidth.

The basic unit of resources in the time-frequency domain is a resource element (RE) 112, which may be represented by an OFDM symbol index and a subcarrier index. A resource block (RB) or a physical resource block (PRB) may be defined by consecutive

$${N}_{sc}^{RB}$$

subcarriers 110 in the frequency domain. In the 5G system,

$${N}_{sc}^{RB} = 12 ,$$

and the data rate may increase in proportion to the number of RBs scheduled for a UE.

In wireless communication systems, a BS may map data at the RB level, and may generally schedule RBs constituting one slot with regard to a specific UE. That is, the basic time unit to perform scheduling in 5G systems may be a slot, and the basic frequency unit to perform scheduling may be an RB.

The number of OFDM symbols,

$${N}_{symb}^{slot} ,$$

is determined according to the length of a cyclic prefix (CP) which is added to each symbol to prevent inter-symbol interference. For example, if a normal CP is applied,

$${N}_{symb}^{slot} = 14$$

and, if an extended CF is applied,

$${N}_{symb}^{slot} = 12.$$

The extended CP is applied to a system having a longer radio-wave transmission distance than the normal CP, thereby maintaining inter-symbol orthogonality. In the normal CP, the ratio between the CP length and the symbol length may be maintained at a constant value such that the overhead due to the CP remains constant regardless of the subcarrier spacing. That is, the symbol length may increase if the subcarrier spacing decreases, thereby increasing the CP length. To the contrary, the symbol length may decrease if the subcarrier spacing increases, thereby decreasing the CP length. The symbol length and the CP length may be inversely proportional to the subcarrier spacing.

To satisfy various services and requirements in wireless communication systems, various frame structures may be supported by adjusting the subcarrier spacing. For example, in terms of the operating frequency band, the larger the subcarrier spacing, the more advantageous for restoration of phase noise in high-frequency bands. In terms of the transmission time, if the subcarrier spacing increases, the symbol length in the time domain decreases. In terms of the cell size, the larger the CP length, the larger the cell that can be supported, meaning that the smaller the subcarrier spacing, the larger the cell that can be supported. The cell refers to a region covered by one BS in connection with mobile communication.

The subcarrier spacing, the CP length, and the like correspond to information indispensable to OFDM transmission/reception, and a BS and a UE need to recognize the subcarrier spacing, the CP length, and the like as mutually common values such that efficient transmission/reception is possible.

Table 1 below describes the relationship between the subcarrier spacing configuration (μ), the subcarrier spacing (Δf), and the CP length supported in 5G systems.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below enumerates the number

$$( {N}_{symb}^{slot} )$$

of symbols per one slot, the number

$$( {N}_{symb}^{slot} )$$

of slots per one frame, and the number

$$( {N}_{slot}^{subframe , μ} )$$

of slots per one subframe with regard to each subcarrier spacing configuration (μ) in a normal CP.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below enumerates the number

$$( {N}_{symb}^{slot} )$$

of symbols per one slot, the number

$$( {N}_{slot}^{frame , μ} )$$

of slots per one frame, and the number

$$( {N}_{slot}^{subframe , μ} )$$

of slots per one subframe with regard to each subcarrier spacing configuration (μ) in an extended CP.

TABLE 3

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In the early phase of introduction of 5G systems, coexistence with legacy LTE and/or LTE-A (LTE/LTE-A) or dual mode operation has been expected. Accordingly, legacy

LTE/LTE-A may provide UEs with stable system operations, and the 5G systems may play the role of providing UEs with improved services. Therefore, the frame structure of 5G systems needs to include at least the frame structure of LTE/LTE-A or an essential parameter set (e.g., subcarrier spacing=15 kHz).

For example, a comparison between a frame structure having a subcarrier spacing configuration μ=0 (hereinafter, frame structure A) and a frame structure having a subcarrier spacing configuration μ=1 (hereinafter, frame structure B) shows that, compared with frame structure A, frame structure B has double the subcarrier spacing and the RB size, and has half the slot length and the symbol length. In frame structure B, two slots may constitute one subframe, and 20 subframes may constitute one frame.

To generalize the frame structure of 5G systems, the subcarrier spacing, the CP length, the slot length, and the like, which constitute a necessary parameter set, of respective frame structures are related so as to correspond to integer multiples with each other, thereby providing a high degree of extendibility. In addition, a subframe having a fixed length of 1 ms may be defined to represent a reference time unit unrelated to the frame structure.

The frame structure may be applied according to various scenarios. In terms of the cell size, the larger the CP length, the larger the cells that can be supported, meaning that frame structure A may support larger cells than frame structure B. In terms of the operating frequency band, the larger the subcarrier spacing, the more advantageous for restoration of phase noise in high-frequency bands. Therefore, frame structure B can support higher operating frequencies than frame structure A. In terms of services, the smaller the slot length (basic time unit of scheduling), the more advantageous to supporting a super-low-latency service such as URLLC, meaning that frame structure B may be more appropriate for an URLLC service than frame structure A.

Herein, the UL may refer to a radio link via which a UE transmits data or control signals to a BS, and the DL may refer to a radio link via which the BS transmits data or control signals to the UE.

In an initial access step in which a UE initially accesses a system, the UE may perform DL time and frequency domain synchronization and acquire a cell identifier (ID) from a synchronization signal, transmitted by a BS, through a cell search. The UE may receive a PBCH by using the acquired cell ID and acquire a master information block (MIB) as mandatory system information from the PBCH. Additionally, the UE may receive a system information block (SIB) transmitted by the BS to acquire cell-common transmission and reception-related control information. The cell-common transmission and reception-related control information may include RA-related control information, paging-related control information, common control information for various physical channels, etc.

A synchronization signal serves as a reference for a cell search, and for each frequency band, a subcarrier spacing may be applied adaptively to a channel environment, such as phase noise. For a data channel or a control channel, to support various services as described above, a subcarrier spacing may be applied adaptively depending on a service type.

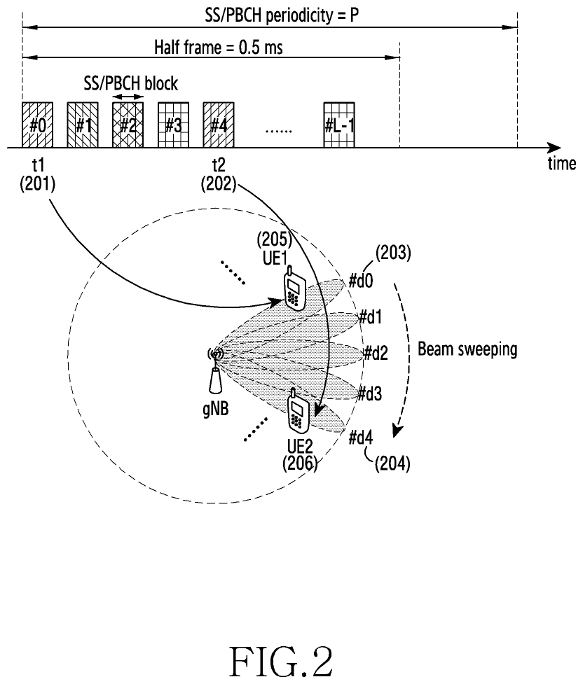

FIG. 2 illustrates a beam sweeping operation and a time domain mapping structure of a synchronization signal according to an embodiment.

For description purposes, the following elements may be defined in advance.

Primary synchronization signal (PSS) serves as a reference for DL time/frequency synchronization, and provides a part of cell ID information.

Secondary synchronization signal (SSS) serves as a reference for DL time/frequency synchronization, and may provide the other part of the cell ID information. Additionally, the SSS may serve as a reference signal for PBCH demodulation of a PBCH.

The PBCH may provide an MIB which is mandatory system information required for transmission and reception of a data channel and a control channel of a terminal. The mandatory system information may include search space-related control information indicating radio resource mapping information of a control channel, scheduling control information for a separate data channel for transmission of system information, a system frame number (SFN) which is a frame unit index that serves as a timing reference, and other information.

Synchronization signal/PBCH block (SS/PBCH block) or synchronization signal block (SSB) may be configured by N OFDM symbols and may include a combination of a PSS, an SSS, a PBCH, etc. For a system to which a beam sweeping technology is applied, an SS/PBCH block may be a minimum unit to which beam sweeping is applied. In the 5G system, N=4 may be satisfied. A BS may transmit up to a maximum of L SS/PBCH blocks, and the L SS/PBCH blocks may be mapped within a half frame (5 ms). The L SS/PBCH blocks may be periodically repeated at predetermined periods P. The BS may inform a UE of period P via signaling. If there is no separate signaling of period P, the UE may apply a previously agreed default value.

Referring to FIG. 2, an example in which beam sweeping is applied in units of SS/PBCH blocks over time is provided. UE 1 205 may receive an SS/PBCH block by a beam emitted in direction #d0 203 by beamforming applied to SS/PBCH block #0 at time point t1 201. UE 2 206 may receive an SS/PBCH block by a beam emitted in direction #d4 204 by beamforming applied to SS/PBCH block #4 at time point t2 202. The UE may acquire, from the BS, an optimal synchronization signal via a beam emitted in the direction where the UE is located. For example, it may be difficult for UE 1 205 to acquire time/frequency synchronization and mandatory system information from the SS/PBCH block through the beam emitted in direction #d4 far away from the location of UE 1.

In addition to the initial access procedure, for determining whether the radio link quality of a current cell is maintained at a certain level or higher, the UE may also receive the SS/PBCH block. During a handover procedure in which the UE moves access from the current cell to an adjacent cell, the UE may receive an SS/PBCH block of the adjacent cell to determine the radio link quality of the adjacent cell and acquire time/frequency synchronization with the adjacent cell.

After acquiring an MIB and system information from the BS through the initial access procedure, the UE may perform an RA procedure to switch a link to the BS to a connected state (or RRC_CONNECTED state). Upon completing the RA procedure, the UE switches to a connected state in which one-to-one communication between the BS and the UE is possible.

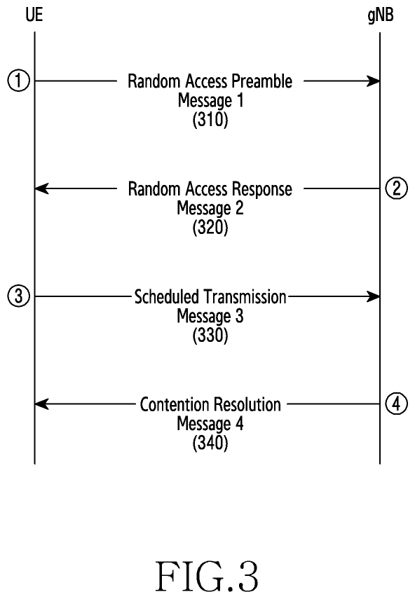

FIG. 3 illustrates a flow of signals for performing an RA procedure according to an embodiment. The disclosure is not limited to a 4-step RA procedure as illustrated in FIG. 3, and may be applied to a 2-step RA procedure (transmission/reception of message A (message including information corresponding to message 1 and message 3) and transmission/reception of message B (message including information corresponding to message 2 and message 4)).

Referring to FIG. 3, in step 310, the UE may transmit an RA preamble to the BS (gNB). The RA preamble, which is a message initially transmitted by the UE in the RA procedure, may be referred to as message 1. The gNB may measure the transmission delay value between the UE and the gNB from the RA preamble, and may conduct UL synchronization. The UE may arbitrarily select which the RA preamble is to be used, from an RA preamble set given by system information in advance. The initial transmission power of the RA preamble may be determined by the pathloss between the gNB and the UE, measured by the UE. The UE may determine the transmission beam direction of the RA preamble from a synchronization signal received from the gNB, thereby transmitting the RA preamble.

In step 320, gNB may transmit an RA response (RAR) (or message 2) regarding the RA preamble received in step 310. The gNB may transmit an UL transmission timing adjustment command to the UE, based on a transmission delay value measured from the RA preamble. The gNB may transmit a power control command and an UL resource to be used by the UE, as scheduling information, to the UE. The scheduling information transmitted by the gNB may include control information regarding the UE's UL transmission beam.

If the UE fails to receive the RAR (or message 2) which is scheduling information regarding message 3 from the gNB within a predetermined time in step 320, the UE may return to step 310, in which the UE may transmit the RA preamble after increasing the transmission power thereof by a predetermined step (power ramping), thereby increasing the probability that the gNB will receive the RA preamble.

In step 330, the UE may transmit UL data (i.e., message 3) including the UE's ID to the gNB by using the UL resource allocated thereto in step 320. The UE may transmit UL data including the UE's ID to the gNB through a physical UL shared channel (PUSCH). The transmission timing of the PUSCH for transmitting message 3 may follow the timing control command received from the gNB in step 320. The transmission power of the PUSCH for transmitting message 3 may be determined in consideration of a power control command received from the gNB in step 320 and the RA preamble's power ramping value. The PUSCH for transmitting message 3 may refer to a UL data signal initially transmitted to the gNB by the UE after the UE has transmitted an RA preamble.

In step 340, upon determining that the UE has performed an RA without contention with other UEs, the gNB may transmit data (message 4) including the ID of the UE which has transmitted UL data in step 330 to the UE. Upon receiving the signal transmitted by the gNB in step 340 from the gNB, the UE may determine that the RA has succeeded. The UE may transmit hybrid automatic repeat request acknowledgement (HARQ-ACK) information to the gNB through a physical UL control channel (PUCCH) to indicate whether or not message 4 has been received successfully.

If the gNB fails to receive a data signal from the UE due to contention between the data transmitted by the UE in step 330 and data from another UE, the gNB may no longer transmit data to the UE. If the UE fails to receive data transmitted from the gNB in step 340 within a predetermined time, the UE may determine that the RA procedure has failed and may restart from step 310.

Upon successfully completing the RA procedure, the UE may be switched to a connected state (or RRC_CONNECTED state), and one-to-one communication between the gNB and the UE may become possible. The gNB may receive UE capability information reported by the UE in the connected state (or RRC_CONNECTED state), and may adjust the scheduling with reference to the UE capability information from the UE. The UE may inform the gNB whether the UE itself supports a specific function, the maximum allowed value of the function supported by the UE, and the like through the UE capability information. Therefore, UE capability information reported to the gNB by each UE may have a different value with regard to each UE.

As an example, the UE may report UE capability information including at least one of the following pieces of control information to the gNB.

Control information regarding the frequency band supported by the UE

Control information regarding the channel bandwidth supported by the UE

Control information regarding the maximum modulation scheme supported by the UE

Control information regarding the maximum number of beams supported by the UE

Control information regarding the maximum number of layers supported by the UE

Control information regarding CSI reporting supported by the UE

Control information regarding whether the UE supports frequency hopping

Control information regarding the bandwidth when carrier aggregation (CA) is supported

Control information regarding whether cross carrier scheduling is supported when CA is supported

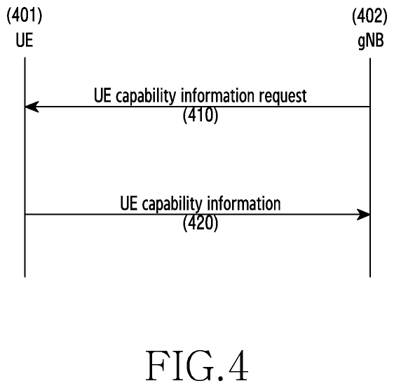

FIG. 4 illustrates a flow of signals used by a UE to report UE capability information to a BS according to an embodiment.

Referring to FIG. 4, in step 410, the BS (gNB) 402 may transmit a UE capability information request message to the UE 401. In step 420, the UE 401 may transmit UE capability information to the gNB, based on the UE capability information request of the gNB 402. The UE 401 may transmit UE capability information to the gNB 402 regardless of the UE capability information request of the gNB 402.

Based on the process in which UE capability information is transmitted/received, the UE connected to the gNB may conduct one-to-one communication with the gNB in the RRC_CONNECTED state. Contrary to the RRC_CONNECTED state, a UE having no connection may be in an RRC_IDLE state, and the UE in the RRC_IDLE state may perform operations as follows:

Perform a UE-specific discontinuous reception (DRX) cycle operation configured by higher layer signaling information

Receive a paging message from the core network

### Acquire System Information

Perform a measurement operation related to the serving cell (or the cell on which the UE is camping) and cell selection/reselection

Perform a neighboring cell-related measurement operation and cell reselection

### Receive Paging Early Indication (PEI)

In the disclosure, higher layer signaling may refer to signaling corresponding to at least one signaling among MIB, SIB or SIB X (X=1, 2, . . . ), RRC, or MAC CE
signaling, or a combination of one or more thereof.

In addition, layer 1 (L1) signaling may correspond to at least one signaling method among signaling methods using the following physical layer channels or signaling, or a combination of one or more thereof.
Physical DL control channel (PDCCH)
DL control information (DCI)
UE-specific DCI
Group common DCI
Common DCI
Scheduling DCI (for example, DCI used for scheduling DL or UL data)
Non-scheduling DCI (for example, DCI not used for scheduling DL or UL data)
PUCCH
UL control information (UCI)

Information transmitted/received between a UE and a BS via higher layer signaling information may also be transmitted/received via various combinations of higher layer signaling information and/or L1 signaling information.

To describe the measurement operation related to the serving cell (or the cell being camped on) and the cell selection/reselection in more detail, the UE may measure synchronization signal-reference signal received power (SS-RSRP) and SS-RSRP levels for the serving cell (or the cell being camped on) at least for each M1*N1 DRX cycle, and may evaluate cell selection determination criterion S based on the measured value. When an SSB-based measurement timing configuration (SMTC) cycle is greater than 20 ms and the DRX cycle is less than or equal to 0.64 s, M1=2, and otherwise, M1=1.

N1 may be determined by Table 4 below.

TABLE 4

| | | |
|---|---|---|
| DRX | N1 | Nₛₑᵣᵥ [number |

| cycle[s] | FR1 | FR2-1 | FR2-2 | of DRX cycles] |
|---|---|---|---|---|
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination criterion S may be met in Srxlev>0 corresponding to SS-RSRP and Squal>0 corresponding to SS-RSRQ in Equations (1) and (2) below.

$$( 1 )$$

$$Srxlev = Qrxlevmeas - ( Qrxlev min + Qrxlev min offset ) - Pcompensation - Qoffettemp$$

$$Squal = Qqualmeas - ( Qqual min + Qqual min offset ) - Qoffsettemp \qquad ( 2 )$$

In Equations (1) and (2), Qrxlevmeas may be the measured SS-RSRP, Qqualmeas may be the measured SS-RSRQ, Qrxlevmin may be the minimum level of the magnitude of the reception signal required in the serving cell and may be received by the UE via system information, and Qqualmin may be the minimum level of the quality of the reception signal required in the serving cell and may be received by the UE via system information. The descriptions of parameters can be found in Table 5 below.

TABLE 5

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2, and SIB4, additionally, if Q_{rxlevminoffsetcellSUL} is |
| | present in SIB3 and SIB4 for the concerned cell, this cell specific offset |
| | is added to the corresponding Qrxlevmin to achieve the required |
| | minimum RX level in the concerned cell; |
| | else Qᵣₓₗₑᵥₘᵢₙ is obtained from q-RxLevMin in SIB1, SIB2, and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the concerned |
| | cell. |
| Q_{qualmin} | Minimum required quality level in the cell (dB). Additionally, if |
| | Q_{qualminoffsetcell} is signaled for the concerned cell, this cell specific offset |
| | is added to achieve the required minimum quality level in the |
| | concerned cell. |
| Q_{rxlevminoffset} | Offset to the signaled Qᵣₓₗₑᵥₘᵢₙ taken into account in the Srxlev |
| | evaluation as a result of a periodic search for a higher priority PLMN |
| | while camped normally in a VPLMN, as specified in TS 23.122 [9]. |
| Q_{qualminoffset} | Offset to the signaled Q_{qualmin} taken into account in the Squal |
| | evaluation as a result of a periodic search for a higher priority PLMN |
| | while camped normally in a VPLMN, as specified in TS 23.122 [9]. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when transmitting on the |
| | UL in the cell (dBm) defined as P_{EMAX} in TS 38.101 [15]. If UE |
| | supports SUL frequency for this cell, P_{EMAX1} and P_{EMAX2} are obtained |
| | from the p-Max for SUL in SIB1 and NR-NS-PmaxList for SUL |
| | respectively in SIB1, SIB2, and SIB4 as specified in TS 38.331 [3], else |
| | P_{EMAX1} and P_{EMAX2} are obtained from the p-Max and NR-NS-PmaxList |
| | respectively in SIB1, SIB2, and SIB4 for normal UL as specified in TS |
| | 38.331 [3]. |
| P_{PowerClass} | Maximum RF output power of the UE (dBm) according to the UE |
| | power class as defined in TS 38.101-1 [15]. |

The UE may determine the SS-RSRP of the serving cell by filtering from at least two measurement values spaced by at least half of the DRX cycle. The UE may determine the SS-RSRQ of the serving cell by filtering from at least two measurement values spaced by at least half of the DRX cycle.

When the UE determines that the serving cell fails to satisfy the cell selection determination criterion S during consecutive Nserv DRX cycles, the UE may initiate measurement of all neighboring cells other than the serving cell. When the UE cannot find a new suitable cell for 10 s, the UE may initiate a cell selection procedure for a selected public land mobile network (PLNM).

To describe the neighbor cell related measurement operation and cell reselection in more detail, when the UE determines that the serving cell fails to satisfy the cell selection determination criterion S during consecutive Nserv DRX cycles, the UE may initiate measurement of all neighboring cells other than the serving cell. When the UE cannot find a new suitable cell for 10 s, the UE may initiate a cell selection procedure for a selected PLNM. The UE, after initiating measurement of the neighbor cells, may measure the SS-RSRP and SS-RSRQ levels at each Tmeasure and evaluate whether the neighbor cells meet the cell reselection determination criteria within each Tevalulate. For newly detected cells, whether the cell reselection determination criterion is satisfied within each Tdetect. When the neighbor cell is better than the serving cell according to the cell reselection determination criterion during Treselection, and simultaneously, more than 1 second elapses after the UE camps on the current serving cell, the UE may reselect the neighbor cell as a new serving cell. The parameters such as Tmeasure, Tevaluate, and Treselection may be determined in the specifications according to the DRX cycle, or may be configured by a higher signal. In determining the measured SS-RSRP, the UE may determine the SS-RSRP of the neighbor cell by filtering at least two measurement values spaced by at least half of Tmeasure.

The cell reselection determination criterion may be used to determine cell selection rankings with reference to Rs and Rn calculated by the parameters below. In other words, cell rankings may be determined in a descending order of values of both Rs and Rn in the following Equations (3) and (4).

$$Rs = Qmeas , s + Qhyst - Qoffsettemp \qquad ( 3 )$$

$$Rn = Qmeas , n - Qoffset - Qoffsettemp \qquad ( 4 )$$

In Equations (3) and (4), Qmeas,s and Qmeas,n refer to the RSRP measurements of the serving cell and the neighbor cell, respectively, and Qhyst, Qoffset, and Qoffsettemp may be configured by the higher signal.

When a specific condition is satisfied in relation to neighbor cell measurement, it is possible to stop neighbor cell measurement or perform neighbor cell measurement in a longer period than Tmeasure. When the UE moves at low speed (e.g., lower than a specific speed) or stops in the cell or when the UE is determined not to be located at the cell boundary, the UE may perform neighbor cell measurement in a period that is longer by the product of Tmeasure and a scaling factor or may stop neighbor cell measurement for up to one hour.

To describe reception of a paging message from a core network in more detail, the UE (i.e., the UE including a main radio only) may monitor one paging occasion (PO) during a DRX cycle. The PO is a set of PDCCH monitoring occasions, and may include multiple time slots (subframes or OFDM symbols) in which paging control information can be received. A paging frame (PF) is one radio frame (10 ms), and may include one or multiple POs or starting points of POs.

The PF and the PO may be determined by Equation (5) below.

$$( SFN + PF\_offset ) mod T = ( T div N ) * ( UE\_ID mod N ) \qquad ( 5 )$$

An SFN for PF is determined by Equation (5) above, wherein PF_offset is an offset for PF determination, T is a DRX cycle, N is the number of (cell common, i.e., cell-specific) PFs per DRX cycle, and is determined by higher layer signaling information, and UE_ID is a UE ID (5G-S-temporary mobile subscriber identity (TMSI)) determined by the core network. The PFs determined by the above N indicate paging frames commonly applied to UEs in a cell, and are referred to as cell-common PFs (cell-specific PFs) in the disclosure.

i_s indicating the PO index is determined by Equation (6) below.

$$i\_s = floor ( UE\_ID / N ) mod Ns \qquad ( 6 )$$

In Equation (6), Ns indicates the number of POs in one PF and is determined, by higher layer signaling information, to be one of the integer values such as 1, 2, 4, . . .

As an example, when it is assumed that PF_offset=3, T=128, N=T/4=32, Ns=4, UE_ID mod 32 is 1, and floor (UE_ID/32) mod 4 is 1, SFN for PF and i_s indicating PO index within the PF in Equation (3) above and Equation (7) below may be determined, for example, as follows.

$$( SFN + 3 ) mod 128 = ( 128 div 32 ) * ( UE\_ID mod 32 ) = 4 * 1 = 4 , \qquad ( 7 )$$

$$i\_s = floor ( UE\_ID / 32 ) mod 4 = 1$$

Accordingly, the PF corresponding to a paging frame that the UE having the UE_ID needs to receive may be determined as a radio frame having SFN of 1, 129, 257, . . . among the cell-common PFs (cell-specific PFs), and the PO may be determined as the (i_s+1)^{th} PO (the 2nd PO in the example above) among the 4 POs in the PF. The PO represents a set of PDCCH monitoring occasions (e.g., “SxX” consecutive PDCCH monitoring occasions). “S” may be the number of actually transmitted SSBs determined according to the ssb-positionsinburst information, which indicates the time domain positions of SSB(s) transmitted in the half frame including the SS/PBCH block and is provided through the RRC information in the NR standard, and the “X” may be “1” in the general case.

A paging early indication (PEI) reception has been introduced to reduce power consumed by a UE while monitoring and receiving a paging control channel and a paging data channel in each DRX cycle. The UE may monitor or receive one PEI occasion (PEI-O) before receiving a paging during a DRX cycle. When the UE receives a PEI and the PEI indicates a paging reception sub-group to which the UE belongs, the UE may monitor the associated paging occasion (PO). When the UE fails to detect the PEI during a PEI occasion, or when the PEI does not indicate a paging reception sub-group to which the UE belongs, the UE does not need to monitor the associated PO, whereby UE power consumption can be reduced.

When the UE determines a PEI occasion, the PEI occasion is spaced apart backwards by the subframe offset with reference to a radio frame of a reference point which is spaced apart forwards by pei-FrameOffset with reference to the PF including the associated PO, and the UE may monitor the PEI in the PEI occasion determined in the manner above. The pei-FrameOffset, subframe offset, and the like may be determined by higher-layer signaling information.

In 5G systems, a new UE state (RRC_INACTIVE) has been defined to reduce the energy and time consumed for the UE's initial access. The RRC_INACTIVE UE may perform the following operations in addition to operations performed by an RRC_IDLE UE.

### Storing Access Stratum (AS) Information Necessary for Cell Access

### UE-Specific DRX Cycle Operation Configured by the RRC Layer

Configuring a radio access control (RAN)-based notification area (RNA) which may be utilized during a handover by the RRC layer, and periodically performing update

### Monitoring a RAN-Based Paging Message Transmitted Through an I-RNTI

The UE in the RRC_CONNECTED state may be changed from the RRC_CONNECTED state to the RRC_INACTIVE or RRC_IDLE state by receiving an RRC Release indication from the gNB.

The UE in the RRC_INACTIVE state may be changed from the RRC_INACTIVE or RRC_IDLE state to the RRC_CONNECTED state by performing the RA to complete all the RA procedures.

Hereinafter, a scheduling method in which the BS transmits DL data to the UE, or indicates the UE's UL data transmission, will be described.

DCI is transmitted from the gNB to the UE through the DL. The DCI may include DL data scheduling information or UL data scheduling information regarding a specific UE. In general, the BS may independently perform channel coding for each UE with regard to the DCI, and may transmit the same to each UE through the PDCCH.

With regard to a UE to be scheduled, the BS may apply and operate a predetermined DCI format according to the purpose, such as whether the same is scheduling information regarding DL data (DL assignment), whether the same is scheduling information regarding UL data (UL grant), or whether the same is DCI for power control.

The BS may transmit DL data to the UE through the PDSCH. The BS may inform the UE of scheduling information, such as detailed mapping locations in time and frequency domains of the PDSCH, the modulation scheme, HARQ-related control information, and power control information, through DCI related to DL data scheduling information among DCI transmitted through a PDCCH.

The UE may transmit UL data to the gNB through the PUSCH. The BS may inform the UE of scheduling information, such as detailed mapping locations in time and frequency domains of the PUSCH, the modulation scheme, HARQ-related control information, and power control information, through DCI related to UL data scheduling information among DCI transmitted through a PDCCH.

The time-frequency resource to which the PDCCH is mapped may be referred to as a control resource set (CORESET). The CORESET may be configured in all or part of frequency resources in a bandwidth supported by the UE in the frequency domain. One or multiple OFDM symbols may be configured as the CORESET in the time domain, and this may be defined as a CORESET duration. The BS may configure one CORESET or multiple CORESETs for the UE through higher layer signaling (for example, SIB, MIB, or RRC signaling). The description that the BS configures a CORESET for the UE indicates that the BS provides the UE with information such as the CORESET identity, the CORESET's frequency location, and the CORESET's symbol length. Pieces of information provided from the BS to the UE to configure a CORESET may include at least a part of the information included in Table 6 below.

TABLE 6

| | |
|---|---|
| ControlResourceSet ::= | SEQUENCE { |

| | |
|---|---|
| controlResourceSetId | ControlResourceSetId, |

(CORESET identity)

| | |
|---|---|
| frequencyDomainResources | BIT STRING (SIZE (45)), |

(frequency domain resources)

| | |
|---|---|
| duration | INTEGER (1..maxCoReSetDuration), |

(CORESET duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

```
          (interleaver size)
          shiftIndex
```

| | |
|---|---|
| INTEGER(0..maxNrofPhysicalResourceBlocks-1) | OPTIONAL -- Need S |

```
          (interleaver shift)
      },
```

| | |
|---|---|
| nonInterleaved | NULL |

},

| | |
|---|---|
| precoderGranularity | ENUMERATED {sameAsREG- |

bundle, allContiguousRBs},
(precoding unit)

| | |
|---|---|
| tci-StatesPDCCH-ToAddList | SEQUENCE(SIZE (1..maxNrofTCI- |

StatesPDCCH)) OF TCI-StateId OPTIONAL, -- Cond NotSIB1-initialBWP
(QCL configuration information)

| | |
|---|---|
| tci-StatesPDCCH-ToReleaseList | SEQUENCE(SIZE (1..maxNrofTCI- |

```
StatesPDCCH)) OF TCI-StateId OPTIONAL, -- Cond NotSIB1-initialBWP
  (QCL configuration information)
    tci-PresentInDCI
```

| | |
|---|---|
| ENUMERATED {enabled} | OPTIONAL, -- Need |

S
(OCL indicator configuration information within DCI)

| | |
|---|---|
| pdcch-DMRS-ScramblingID | INTEGER (0..65535) |

OPTIONAL, -- Need S
(PDCCH DMRS scrambling identity)
}

A CORESET may be configured by

$${N}_{RR}^{CORESET}$$

RBs in the frequency domain and may be configured by

$${N}_{symb}^{CORESET} ∈ \{ 1 , 2 , 3 \}$$

symbols in the time domain. An NR PDCCH may be configured by one or multiple control channel elements (CCEs). One CCE may be configured by six resource element groups (REGs), and each REG may be defined as one RB during one OFDM symbol. In one CORESET, REGs may be indexed in the time-first order starting from REG index 0, from the lowest RB of the first OFDM of the CORESET.

As a PDCCH-related transmission method, an interleaved type and a non-interleaved type may be supported. The BS may configure, for the UE, whether interleaved or non-interleaved transmission is performed with regard to each CORESET through upper layer signaling. Interleaving may be performed at the REG bundle level. The REG bundle may be defined as one REG or a set of multiple REGs. The UE may determine the CCE-to-REG type in the corresponding CORESET, based on the configuration by the gNB regarding whether transmission is of the interleaved type or the non-interleaved type, as in Table 7 below.

TABLE 7

```
The CCE-to-REG mapping for a control-resource set can be interleaved or non-
interleaved and is described by REG bundles:
  - REG bundle i is defined as REGs {iL, iL + 1, ... , iL + L − 1} where L is
      $the REG bundle size , i = 0 , 1 , ... , {N}_{REG}^{CORESET} / L - 1 , and {N}_{REG}^{CORESET} = {N}_{RB}^{CORESET} {N}_{symb}^{CORESET} is the number of REGs in the CORESET$
  - CCE j consists of REG bundles {f(6j/L), f(6j/L + 1), ... , f(6j/L +
      6/L − 1)} where f (·) is an interleaver
For non-interleaved CCE-to-REG mapping, L = 6 and f (x) = x.
$For interleaved CCE - to - REG mapping , L ∈ \{ 2 , 6 \} for {N}_{symb}^{CORESET} = 1 and L ∈ \{ {N}_{symb}^{CORESET} , 6 \} for {N}_{symb}^{CORESET} ∈ \{ 2 , 3 \} . The interleaver is defined by$
$C = {N}_{REG}^{CORESET} / ( LR )$
where R ∈ {2,3,6}.
```

The BS may provide the UE with configuration information regarding the symbol to which the PDCCH is mapped in the slot, the transmission period, and the like through signaling.

A description of a search space for a PDCCH is as follows. The number of CCEs necessary to transmit a PDCCH may be 1, 2, 4, 8, or 16 according to aggregation levels (ALs), and different number of CCEs may be used to implement link adaption of a DL control channel. For example, in AL=L, one DL control channel may be transmitted through L CCEs. The UE performs blind decoding for detecting a signal while being no information regarding the DL control channel, and to this end, a search space indicating a set of CCEs may be defined. The search space is a set of DL control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

The search spaces may be classified into common search spaces (CSSs) and UE-specific search spaces (USSs). A group of UEs or all UEs may search a CSS of the PDCCH to receive cell-common control information such as dynamic scheduling regarding system information or a paging message. For example, the UE may receive PDSCH scheduling allocation information for reception of system information by searching the CSS for the PDCCH. In a CSS, a group of UEs or all UEs need to receive the PDCCH, and the CSS may thus be defined as a predetermined set of CCEs. Scheduling allocation information regarding a UE-specific PDSCH or PUSCH may be received by searching the UE-specific search space for the PDCCH. The UE-specific search space may be defined UE-specifically as a function of various system parameters and the identity of the UE.

Configuration information of the search space for the PDCCH may be configured for the UE by the BS through upper layer signaling (e.g., SIB, MIB, or RRC signaling). For example, the BS may provide the UE with configurations such as the number of PDCCH candidates at each aggregation level L, the monitoring cycle regarding the search space, the monitoring occasion with regard to each symbol in a slot regarding the search space, the search space type (CSS or UE-specific search space), a combination of an RNTI and a DCI format to be monitored in the corresponding search space, a CORESET index for monitoring the search space, and the like. For example, parameters of the search space for the PDCCH may include the following pieces of information given in Table 8 below.

TABLE 8

| SearchSpace ::= | | SEQUENCE { |
|---|---|---|
| | searchSpaceId | SearchSpaceId, |

(search space identity)

controlResourceSetId

| | |
|---|---|
| ControlResourceSetId | OPTIONAL, -- Cond |

SetupOnly
(CORESET identity)

monitoringSlotPeriodicityAndOffset CHOICE {

(monitoring slot level periodicity and offset)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}

OPTIONAL, -- Cond Setup

| | |
|---|---|
| duration | INTEGER (2..2559) |

OPTIONAL, -- Need R
(monitoring duration)

| | |
|---|---|
| monitoringSymbolsWithinSlot | BIT STRING (SIZE (14)) |

OPTIONAL, -- Cond Setup
(monitoring symbol location within slot)

| | |
|---|---|
| nrofCandidates | SEQUENCE { |

(number of PDCCH candidates at each aggregation level)

| | |
|---|---|
| aggregationLevel1 | ENUMERATED {n0, n1, |

n2, n3, n4, n5, n6, n8},

| | |
|---|---|
| aggregationLevel2 | ENUMERATED {n0, n1, |

n2, n3, n4, n5, n6, n8},

| | |
|---|---|
| aggregationLevel4 | ENUMERATED {n0, n1, |

n2, n3, n4, n5, n6, n8},

| | |
|---|---|
| aggregationLevel8 | ENUMERATED {n0, n1, |

n2, n3, n4, n5, n6, n8},

| | |
|---|---|
| aggregationLevel16 | ENUMERATED {n0, n1, |

n2, n3, n4, n5, n6, n8}

}

OPTIONAL, -- Cond Setup

| | |
|---|---|
| searchSpaceType | CHOICE { |

(search space type)

| common | SEQUENCE { |
|---|---|
| (CSS) | |
| dci-Format0-0-AndFormat1-0 | SEQUENCE { |

```
            ...
          }
```

OPTIONAL, -- Need R

| | dci-Format2-0 | SEQUENCE { |
|---|---|---|
| | nrofCandidates-SFI | SEQUENCE { |
| | aggregationLevel1 | ENUMERATED |
| {n1, n2} | OPTIONAL, -- Need R | |
| | aggregationLevel2 | ENUMERATED |
| {n1, n2} | OPTIONAL, -- Need R | |
| | aggregationLevel4 | ENUMERATED |
| {n1, n2} | OPTIONAL, -- Need R | |
| | aggregationLevel8 | ENUMERATED |
| {n1, n2} | OPTIONAL, -- Need R | |
| | aggregationLevel16 | ENUMERATED |

| | |
|---|---|
| {n1, n2} | OPTIONAL -- Need R |
| | }, |
| | ... |
| | } |

OPTIONAL, -- Need R

| | |
|---|---|
| dci-Format2-1 | SEQUENCE { |

```
            ...
          }
```

OPTIONAL, -- Need R

| | |
|---|---|
| dci-Format2-2 | SEQUENCE { |

```
            ...
          }
```

OPTIONAL, -- Need R

| | |
|---|---|
| dci-Format2-3 | SEQUENCE { |
| dummy1 | ENUMERATED |

{sl1, sl2, sl4, sl5, sl8, sl10, sl16, sl20} OPTIONAL, -- Cond Setup

| | |
|---|---|
| dummy2 | ENUMERATED |

{n1, n2},

```
            ...
          }
```

OPTIONAL -- Need R

| }, | |
|---|---|
| ue-Specific | SEQUENCE { |
| (UE-specific search space) | |
| dci-Formats | ENUMERATED |

{formats0-0-And-1-0, formats0-1-And-1-1},

```
          ...,
      }
}
```

OPTIONAL -- Cond Setup2
}

Based on configuration information, the BS may configure one or multiple search space sets for the UE. The BS may configure search space set 1 and search space set 2 for the UE. In search space set 1, the UE may be configured to monitor DCI format A scrambled by an X-RNTI in a CSS, and in search space set 3, the UE may be configured to monitor DCI format B scrambled by a Y-RNTI in a UE-specific search space.

According to the configuration information transmitted by the BS, a CSS or a UE-specific search space may include one or multiple search space sets. For example, search space set #1 and search space set #2 may be configured as a CSS, and search space set #3 and search space set #4 may be configured as a UE-specific search space.

In a CSS, the UE may monitor combinations of DCI formats and RNTIs given below but are not limited thereto.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the UE may monitor combinations of DCI formats and RNTIs given below but are not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may follow the definition and usage given below but are not limited thereto.
Cell RNTI (C-RNTI) schedules a UE-specific PDSCH
Temporary cell RNTI (TC-RNTI) schedules a UE-specific PDSCH
Configured scheduling RNTI (CS-RNTI) schedules a semi-statically configured UE-specific PDSCH
RA RNTI (RA-RNTI) schedules a PDSCH in a RA step
Paging RNTI (P-RNTI) schedules a PDSCH in which paging is transmitted
System information RNTI (SI-RNTI) schedules a PDSCH in which system information is transmitted
Interruption RNTI (INT-RNTI) indicates whether a PDSCH is punctured
Transmit power control for PUSCH RNTI (TPC-PUSCH-RNTI) indicates a power control command regarding a PUSCH
Transmit power control for PUCCH RNTI (TPC-PUCCH-RNTI) indicates a power control command regarding a PUCCH
Transmit power control for SRS RNTI (TPC-SRS-RNTI) indicates a power control command regarding an SRS
The DCI formats enumerated above may follow the definitions given in Table 9 below.

TABLE 9

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) |
| | and OFDM symbol(s) where UE may assume |
| | no transmission is intended for the UE |
| 2_2 | Transmission of TPC commands for PUCCH and PUSCH |
| 2_3 | Transmission of a group of TPC commands |
| | for SRS transmissions by one or more UEs |

In 5G, the search space at aggregation level L in connection with CORESET p and search space set s may be expressed by Equation (8) below.

$$L \cdot \{ ( {y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad ( 8 )$$

In Equation (8):
L: aggregation level
n_{CI}: carrier index
N_{CCE,p}: total number of CCEs existing in CORESET p

$${n}_{s , f}^{μ} :$$

slot index

$${M}_{s , max}^{( L )} :$$

number of PDCCH candidates at aggregation level L
m_{s,n}_{_{CI}}=0, . . . ,

$${M}_{s , max}^{( L )} - 1 :$$

PDCCH candidate index at aggregation level L i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39829 for pmod3=1, Aₚ=39829 for pmod3=1, Aₚ=39839 for pmod3=2, D=65537
n_{RNTI}: UE identity

The

$${Y}_{p , {n}_{s , f}^{μ}}$$

value may correspond to 0 in a CSS.

The

$${Y}_{p , {n}_{s , f}^{μ}}$$

value may correspond to a value changed by the UE's identity (C-RNTI or ID configured for the UE by the BS) and the time index in a UE-specific search space. In the cell that operates TDD, the BS may transmit/receive signals including data/control information in a DL slot (or symbol), an UL slot (or symbol) 1201, or a flexible slot (or symbol), based on configurations regarding TDD UL-DL resource configuration information indicating DL slot (or symbol) resources and UL slot (or symbol) resources of a legacy TDD UE or an SBFD-capable UE and TDD. The above configuration may be received via system information or RRC.

It may be assumed that a “DDDSU” slot format is configured according to the TDD UL-DL resource configuration information. In this regard, “D” denotes a slot entirely configured by DL symbols, “U” denotes a slot entirely configured by UL symbols, and “S” denotes a slot which is neither “D” nor “U,” for example, a slot including DL symbols and UL symbols or including flexible symbols. Also, the DDDSU slot format may be repeated according to the TDD UL-DL resource configuration information. That is, the repetition period of a TDD configuration is 5 slots (5 ms in 15 kHz SCS, 2.5 ms in 30 kHz SCS, etc.). Whether the flexible symbols can be used as the DL or UL symbols may be periodically indicated to the UE via the above-described DCI format 2_0. The TDD UL-DL resource configuration may be repeated according to TDD periodicity. A slot unit or symbol unit is cell-specific information, and may be configured along with the periodicity configuration.

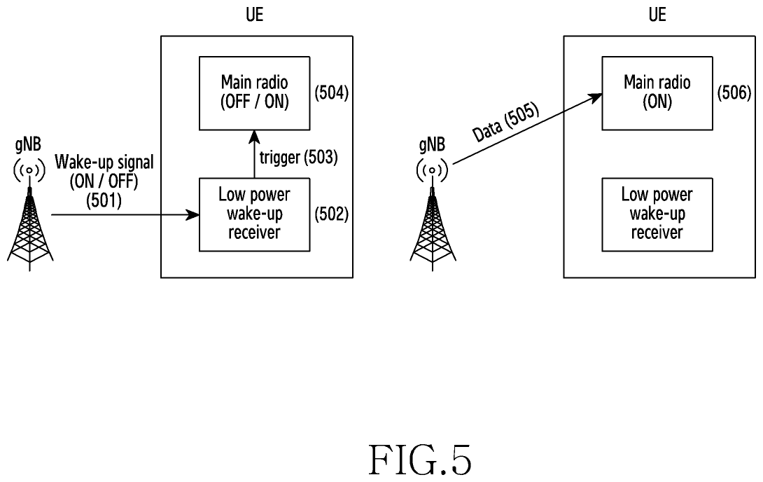

FIG. 5 illustrates a state transition between a BS and a UE and the state of the UE based on the state of the BS according to an embodiment. Referring to FIG. 5, a state transition between a BS and a UE to solve the above-described problem is described, but the disclosure is not limited thereto.

A 5G UE (or a UE beyond 5G) may need to periodically wake up once per eDRX cycle, which may dominate power consumption during periods when there is no signaling or data traffic between the UE and the BS. If the UE may wake up only when triggered, such as by paging, power consumption may be drastically reduced. A groundbreaking power consumption reduction scheme can be achieved, as illustrated in FIG. 5, by triggering a main radio (e.g., an existing NR radio) by using a wake-up signal (WUS), and only when data transmission and reception are required, turning on the main radio by using a WUR corresponding to a separate receiver capable of monitoring the WUS with ultra-low power. The main radio and the WUR may include at least one of a transceiver which is included in the UE and transmits and receives radio signals, a modem for encoding/decoding the transmitted and received signals, and a component(s) that consumes power within the UE. Alternatively, the main radio and the WUR may be understood as the UE itself, in which case the UE may operate so as to consume only the minimum power required for receiving the WUS until the WUS is received. The terms such as “main UE” and “transceiver” may be interchangeably used with “main radio”.

In step 501, the BS may transmit a WUS corresponding to ON or OFF to the UE. The BS may transmit the WUS to the UE, and the WUS may include ON information or OFF information. The WUS indicating ON may trigger an ON state in which the main radio operates, and the WUS indicating OFF may trigger an OFF state in which the main radio does not operate (or operates minimally). Optionally, the WUS may indicate an ON state in which the main radio operates, and the UE having received the paging upon reception of the WUS may perform an operation according to the paging and then switch the main radio back to the OFF state without receiving the WUS indicating the OFF state of the main radio or a separate signal.

In step 502, the UE may receive the WUS from the BS by using a WUR (or a low power WUR).

In step 503, the UE may trigger the main radio to the OFF or ON state based on information indicating that the received WUS corresponds to ON or OFF. For example, triggering the main radio may indicate triggering a state transition for the main radio. For example, triggering the main radio may indicate triggering for transitioning the main radio in the OFF state to the ON state, triggering for transitioning the main radio in the ON state to the OFF state, etc.

In step 504, the UE may wake up the main radio or configure the main radio to a power-off state, based on the WUS. For example, configuring the main radio to a power-off state may indicate that the main radio is completely turned off. The UE may also configure the main radio to a deep sleep (DS) or an ultra-deep sleep (UDS) state rather than a completely OFF state, based on the WUS.

Whether the main radio is in the completely OFF, DS, or UDS state may be distinguished based components within the main radio, which can be turned off. For example, when the main radio is completely OFF, all components within the main radio may be OFF. When the main radio is in the DS state, an oscillator, radio frequency-front end (RF-FE), and a baseband modem may be OFF, while a control processor and a double data rate (DDR) memory may still be ON. When the main radio is in the UDS state, the oscillator, RF-FE, and baseband modem may be OFF, and the control processor and DDR memory may also operate at very low power or may be OFF. The power consumption of the main radio decreases in the order of DS state=>UDS state=>OFF state.

In step 505, when data traffic to be transmitted from the BS to the UE occurs and the WUS transmitted by the BS in step 501 is a signal corresponding to ON, the main radio of the UE may be ON and the UE may receive the data transmitted by the BS through the main radio rather than the WUR in step 506. That is, when the BS transmits the WUS corresponding to ON in step 501, the main radio of the UE may be ON. The BS may transmit data in step 505, and the UE may receive data through the main radio in step 506.

The power consumption for monitoring the WUS depends on the hardware modules of the WUR used for designing the WUS and detecting and processing signals so that the benefits can be maximized for IoT use cases (such as industrial sensors and controllers) and various devices including wearable devices (e.g., a foam factor device that is power consumption sensitive and compact, or the like).

The UE including the WUR may report to the BS that the UE has capability to wake up the main radio by using the WUR, or report capability information indicating that the UE includes the WUR to the BS.

The UE may also report capability information about the WUR to the BS through the UE capability information reporting procedure in FIG. 4.

Referring back to FIG. 4, the UE having received a request for UE capability information from the BS in step 410 may transmit, to the BS, UE capability information including capability information about a WUR in step 420. Even when there is no request from the BS in step 410, it may be possible for the UE to provide capability information about the WUR to the BS.

In the RA procedure of operations 310 to 340 in FIG. 3, the UE may report capability information about the WUR to the BS through at least one of step 310 of transmitting an RA preamble and step 330 of transmitting a scheduled transmission (message 3) according to the RA procedure on an UL data channel.

Information on sets of RA preambles that the UE including the WUR may transmit may be transmitted to the UE through higher layer signaling information. The UE may select an RA preamble from among the sets received by the UE, and may transmit, based on the selected RA preamble, the RA preamble in step 310.

After reporting capability information about the WUR to the BS, the UE may receive information indicating whether to use the WUR from the BS through higher layer signaling information or L1 signaling information.

When the BS supports the UE including a WUR (for example, a case where the BS includes hardware capable of transmitting a WUS), the BS may determine whether to use the WUR after receiving capability information about the WUR from the UE.

The BS may transmit, to the UE, higher layer signaling information and/or L1 signaling information including whether to use the WUR or configuration information for receiving the WUS.

The BS may transmit, to the UE, at least one of indication information indicating reception of the WUS by the UE or activation of the WUR and indication information notifying that the BS transmits the WUS. For example, after a slot configured by the BS (or defined in the 3GPP standard) from a slot in which the UE WUS is received, the UE may turn off the main radio and turn on the WUR for monitoring the WUS. The UE may transmit, to the BS, at least one of feedback information indicating that the WUS indicating whether to use the WUR has been received before turning off the main radio and feedback information indicating that the main radio has been turned off and the WUR has been turned on.

When the BS does not support the UE including the WUR, the BS may receive capability information about the WUR from the UE and then transmit, to the UE, a signal indicating that the WUR is unusable. In this case, the UE may transmit, to the BS, that the feedback information indicating that the signal indicating that the WUR is unusable has been received. The UE may use the conventional power saving method (connected mode DRX (C-DRX) or idle mode DRX (I-DRX) such as paging) as in the relevant standard to perform an operation according to parameters of the conventional power saving method configured by the BS.

The UE may determine whether to activate or deactivate the WUR, based on reception of the WUS transmitted from the BS.

The UE may also determine whether to activate or deactivate the WUR, based on reception of a synchronization signal (LP-SS or SSB) of the WUR transmitted from the BS. The expression “based on reception of a signal” above means that the determination is made based on a result value obtained by measuring the quality of the signal or a metric value such as a reception error rate of the signal. In this case, when whether to activate or deactivate the WUR is determined, comparison with a specific value defined in the standard or comparison with a threshold value received from the BS via a higher signal may be performed.

After the WUR is activated, the WUR may continuously or discontinuously monitor the WUS. When the WUS is continuously monitored, the WUR of the UE may be always in the ON state. When the WUS is discontinuously monitored, the state of the WUR of the UE may be repeated between the OFF state and the ON state. The UE may receive period and offset configurations (in the time domain) in which monitoring of the WUS through the WUR needs to be performed or period and offset configurations (in the time domain) in which the WUR needs to be in the ON state from the BS through a higher layer signal in advance. When there is no period and offset configurations or the period and offset configurations fail to be received from the BS, the UE may determine to continuously monitor the WUS.

After the procedure of reporting the capability of the UE including the WUR and receiving information about whether the BS supports (or permits) the WUR, the WUR of the UE according to an embodiment may perform an operation of turning on and off the main radio of the UE, based on the WUS.

The UE may independently perform the operation to turn the main radio on/off and the operation of reporting the capability of the UE including the WUR or the procedures for receiving information about whether the WUR is supported from the BS. For example, even when the capability report operation of the UE and the permission procedure for use of the WUR from the BS are not performed, the BS may transmit, to the UE, a signal indicating whether the WUR is used or configuration information for receiving the WUS. Accordingly, the UE including the WUR among the UEs receiving the signal from the BS may turn on/off of the main radio through the WUR.

After the capability report operation of the UE and the permission procedure for use of the WUR from the BS are performed, the operation of turning on/off of the main radio through the WUR may be applied to all or some of the UEs within the cell supported by the BS (e.g., RRC_CONNECTED UEs, RRC_IDLE/RRC_INACTIVE UEs, or UEs connecting to the cell (e.g., RRC_CONNECTED UEs)). When the UE capability reporting operation and BS permission procedure are not performed, the operation of turning on/off the main radio via the WUR may be applied to RRC_IDLE/RRC_INACTIVE UEs that camp on within the cell supported by the BS.

Hereinafter, embodiments of the disclosure may include at least one of all, some, or a combination of parts of various operations of the UE including the WUR and the BS supporting such a UE.

While an operation of turning on and off the main radio of the UE including the WUR is described, embodiments of the disclosure may include at least one of all, some, or a combination of parts of various operations of the UE including the WUR and the BS.

When the main radio of the UE is in the ON state, the UE may receive a DL signal (or data) from the BS through the main radio. Herein, the main radio being “on” may be expressed as the main radio being “turned on” or the main radio “being activated”, and being on or on of the main radio (or transceiver) is not limited thereto and may have a similar or substantially equivalent meaning. The activation of the main radio may indicate that all or at least some of specific components of the main radio (e.g., radio frequency (RF), baseband (BB), or the like) are turned on or activated, or may be defined by the standard (e.g., 3GPP technical specification (TS) document). However, according to various embodiments of the disclosure, the activation of the main radio is not limited to the description above, and may include performing an operation by a parameter or parameters having equivalent or substantially similar contents thereto.

Alternatively, the activation of the main radio may include performing, by the main radio, a reception operation of a specific channel or signal (e.g., an SS/PBCH block including a synchronization signal or a PDCCH including a DL control channel) defined in the 3GPP TS document.

When the main radio of the UE is in the OFF state, the UE may be considered to be in a sleep period or may not receive a DL signal (or data) from the BS. The main radio being “OFF” may be expressed as the main radio being “turned off” or the main radio being “deactivated”, and may have a similar or substantially equivalent meaning thereto, without being limited thereto.

The main radio being deactivated may indicate that all or at least some of specific components (e.g., radio frequency (RF), baseband (BB), or the like) of the main radio are turned off or deactivated, or may be defined by the standard (e.g., 3GPP TS document). However, the deactivation of the main radio is not limited to the description above, and may include performing an operation by a parameter or parameters having equivalent or substantially similar contents thereto. Alternatively, the deactivation of the main radio may include a meaning that the main radio no longer performs a reception operation of a specific channel or signal (e.g., an SS/PBCH block including a synchronization signal or a PDCCH including a DL control channel) defined in the 3^{rd} generation partnership project (3GPP) technical specification (TS) document.

As described above, to reduce power consumption in the UE, when the UE receives the WUS from the BS (or when receiving the WUS indicating an ON state of the main radio), the UE may trigger the main radio to be turned on via the WUR so that the main radio can receive a DL signal from the BS, and when the UE does not receive the WUS (or when receiving the WUS indicating an OFF state), the UE may turn off the main radio. Optionally, the on/off operation of the main radio based on the reception of the WUS may also be applied to the RA procedure and UL transmission of the UE.

In this case, the UE in the RRC IDLE or RRC INACTIVE state may receive the WUS, receive the PEI according to the implementation of the UE, or attempt to receive paging in the PO/PF. In this case, for time/frequency synchronization before the UE receives the WUS, the UE needs to receive a WUR-dedicated synchronization signal (LP-SS), and a method thereof is described in the disclosure.

A quasi-co-location (QCL) relationship (or spatial relation or beam association) between the WUR-dedicated synchronization signal and the synchronization signal of the existing UE described in FIG. 2 is defined, and a UE procedure for the WUR-dedicated synchronization signal to be received by the WUR and the synchronization signal to be received by the main radio is described using the QCL relationship.

When using the QCL relationship (QCL relation or QCL assumption), it may indicate that the same spatial domain filter when the UE receives an SSB and when the UE receives an LP-SS.

The QCL relationship in the disclosure may include at least one of the pieces of information below and may be transmitted from the BS to the UE via a higher-layer signal.

Beam information related to one or multiple SSBs or channel state information reference signals (CSI-RSs), i.e., beam related information (or TCI state) including one or multiple SSB indices or one or more CSI-RS source IDs TCI state ID One or more pieces of QCL information

The QCL information may include a cell ID, a BWP ID, information on one or more multiple reference signals (e.g., CSI-RS ID information when a reference signal is a CSI-RS and SSB index information when the reference signal is an SSB), and information on whether the QCL type is type A, type B, type C, or type D.

In describing embodiments below, the operations or procedures described as being performed by the main radio or WUR for the UE including the WUR (i.e., the UE having capability of wake-up reception) may also be understood as being performed by the UE including the WUR (i.e., the UE having capability of wake-up reception).

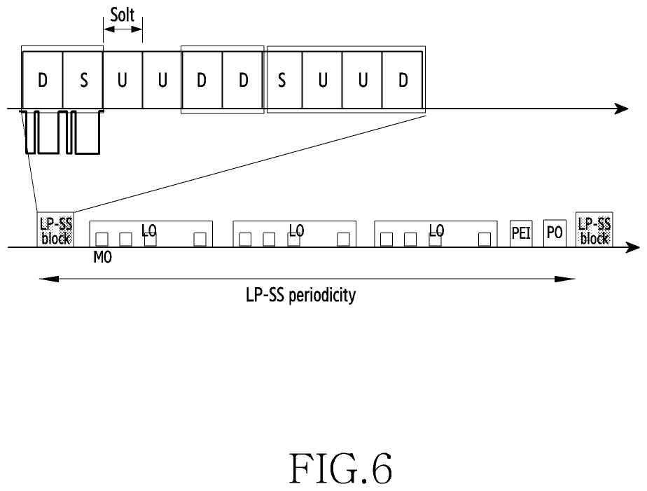

For example, receiving a signal/channel by the WUR may be understood as the UE (and/or a processor included in the UE) receiving the signal/channel through the WUR (or by using the WUR). Performing measurement by the WUR may be understood that the signal/channel, or the like for measurement is received through the WUR, and the UE (and/or a processor included in the UE) performs the measurement operation based on the reception. In the embodiments of FIGS. 6 to 9 below, for convenience of description, receiving the WUR-dedicated synchronization signal and the WUS by the UE may also be understood as receiving the WUR-dedicated synchronization signal by the WUR for the purpose of synchronization, and receiving the WUR for indicating the ON state of the main radio by the UE.

The BS may transmit the WUR-dedicated synchronization signal to support synchronization of the WUR by the UE, the BS may transmit paging in the PF or PO determined based on transmission of the WUS, and the UE may receive paging in the PF and PO determined based on reception of the WUS.

Information provided via higher-layer signaling information may be provided through a combination of at least one of the above-described higher-layer signaling information and L1 signaling information.

FIG. 6 illustrates configuring a resource for transmitting or receiving a WUR-dedicated synchronization signal according to an embodiment.

A system in which a WUR-dedicated synchronization signal is transmitted or received may be an FDD or TDD system, but FIG. 6 illustrates the TDD system. The UE may determine, based on configuration of TDD UL-DL resource configuration information indicating a DL slot (or symbol) and an UL slot (or symbol) of the TDD and DCI format 2_0, whether a slot or symbol is a DL slot/symbol, an UL slot/symbol, or a flexible slot/symbol.

Referring to FIG. 6, the WUR-dedicated synchronization signal (LP-SS) may be basically designed based on a waveform that can be received by a WUR. For example, in a WUR capable of receiving OFDM, an SSB may be used as a synchronization signal for the WUR, and in a WUR capable of ON-OFF keying (OOK), a synchronization signal generated based on OOK may be used as a synchronization signal for the WUR. In FIG. 6, it is assumed that the synchronization signal for the WUR is generated and transmitted based on the OOK so that the WUR can be received with low power through minimum receiver complexity. For operation of the WUR-dedicated synchronization signal, multiple synchronization signals for distinguishing cells may be defined in the standard, and one of the multiple synchronization signals may be selected by the configuration of the BS or a predetermined rule and transmitted in a cell as a WUR-dedicated synchronization signal. Information required for reception of the WUR-dedicated synchronization signal may be configured by a higher signal. The information required for reception of the WUR-dedicated synchronization signal may include, for example, information such as the time/frequency position of the WUS, the number of ON-OFF patterns in one OFDM symbol (i.e., whether it is OOK-1, OOK-4 of M=2, or OOK-4 of M=4), the number of OFDM symbols through which the WUR-dedicated synchronization signal is transmitted (i.e., the number of transmission symbols), a transmission period of the WUR-dedicated synchronization signal, a transmission start position of the WUR-dedicated synchronization signal, and a subcarrier spacing (SCS) applied to the WUR-dedicated synchronization signal. FIG. 6 illustrates that one LP-SS is transmitted over two slots, and two LP-SSs may be transmitted through two different beams.

A specific number of consecutive slots are configured from a start point of the LP-SS, and in a DL, UL, and flexible slot/symbol having a TDD configuration, determined by a higher signal or DCI, only an LP-SS not overlapping with the UL slot/symbol among the LP-SSs including the specific number of consecutive slots from the start point may be selected as an

LP-SS. In this case, the resources of the selected LP-SS may not be consecutive. As illustrated in FIG. 6, the LP-SS may include only a DL or flexible slot/symbol in the DL, UL, and flexible slot/symbol having a TDD configuration, determined by the higher signal or DCI. The resources of the LP-SS include only the DL or flexible slot/symbol from the start point, and the indices of the configured LP-SS may be consecutive. The transmission start point of the LP-SS may be the first symbol of the 0^{th} radio frame, and may be a specific symbol a specific radio frame. The start point may be defined in the standard, or may be configured by the BS through the higher signal.

In addition, an occasion for WUS monitoring of the UE may be referred to as an LP-WUS occasion, and may be referred to as an LO in the disclosure for convenience of description. Each LO may include one or multiple LP-WUS monitoring occasions (MOs), and the UE may monitor and receive the WUS in each MO. Each LO may include N*K Mos, N is the number of beams corresponding to one WUS, and K is the number of MOs in each beam.

The UE may receive a synchronization signal such as an LP-SS or an SSB corresponding to each beam before monitoring the LO to determine a beam corresponding to the MO, and the UE may determine a beam direction optimized for the UE through reception of the synchronization signal.

During reception of the synchronization signal, to determine a beam direction optimized for the UE, the UE may determine a beam direction having the highest reception reliability only when the UE receives all beam directions of the synchronization signal such as the LP-SS or the SSB. However, the UE may have a delay issue for receiving all beam directions.

Accordingly, to solve the delay issue caused when the UE needs to receive all beam directions of the synchronization signal, the disclosure proposes a method of defining beam association or QCL relationship between the LP-SS and the SSB. Through the definition of the beam association, the following advantages can be provided.

When a WUR is activated while the UE operates using a main radio only, the UE may detect only a WUR-dedicated synchronization signal that is QCL-ed with the SSB determined as the best reception beam by the UE when the UE operates using the main radio only. As the UE detects only the WUR-dedicated synchronization signal that is QCL-ed with the SSB determined to be the best reception beam by the UE, the complexity that the UE needs to detect the WUR-dedicated synchronization signal in all beam directions can be reduced, and accordingly, UE power can be reduced. In addition, when the WUR wakes up the main radio of the UE, the UE may detect only an SSB that is QCL-ed with the LP-SS that is determined to be the best reception beam by the WUR of the UE. Accordingly, the complexity that the SSB in all beam directions needs to be detected can be reduced, and a PEI may be received or a paging message may be received in the PO through the most recent SSB rather than the SSB determined to be the best reception beam before.

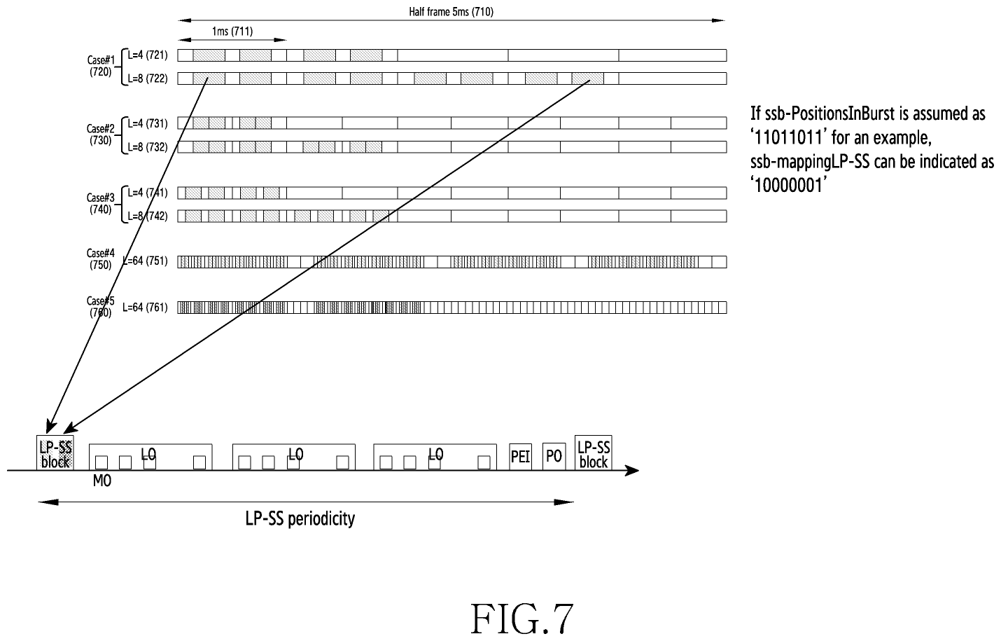

Hereinafter, a method for defining beam association between the SSB and the LP-SS is described through FIGS. 7, 8, and 9.

FIG. 7 illustrates a QCL between a WUR-dedicated synchronization signal and a legacy synchronization signal according to an embodiment.

Referring to FIG. 7, a method of defining beam association between an SSB and an LP-SS actually transmitted by a stations is illustrated. Specifically, a method of minimizing a resource required to transmit an LP-SS is disclosed by configuring information on an LP-SS having beam association with some SSBs among the SSBs actually transmitted by the BS, and supporting the LP-SS only in the required beam direction.

Information on the SSB actually transmitted by the BS in the cell may be configured by ssb-PositionInBurst. For example, when a bit field of ssb-PositionInBurst is configured as “11011011”, six SSB bursts among a total of eight SSBs within 5 ms may be transmitted. The BS may configure ssb-mappingLP-SS as information for indicating an SSB that is QCL-ed with the LP-SS among the SSBs indicated by the ssb-PositionInBurst. The term “ssb-mappingLP-SS” is merely provided as an example, and the embodiments described in the disclosure are not limited thereto. For example, when ssb-mappingLP-SS has 8-bit information such as ssb-PositionInBurst and is configured as “10000001”, the ssb-mappingLP-SS configured as “10000001” may indicate that the LP-SS that is QCL-ed with the first and the last SSBs among the six actually transmitted SSB bursts is transmitted. An SSB having beam association with the LP-SS among the SSBs actually transmitted by the BS may be indicated through a higher signal such as ssb-mappingLP-SS, and the LP-SS may be transmitted only in the required beam direction. In another example, when the ssb-mappingLP-SS has 6-bit information that is identical to the number of SSBs actually transmitted in the ssb-PositionInBurst and is configured as “100001”, the ssb-mappingLP-SS may indicate that the LP-SS QCL-ed with the first and last SSBs among the six actually transmitted SSB bursts is transmitted. In this case, bit values having “1” from bit string “11011011” of ssb-PositionInBurst may be sequentially mapped in the direction from a most significant bit (MSB) to a least significant bit (LSB) and in the direction from the MSB to the LSB of a 6-digit bit string of the ssb-mappingLP-SS. According to the method, the size of the ssb-mappingLP-SS is a size corresponding to the number of actually transmitted SSBs, indicated through the ssb-PositionInBurst, and may be flexibly configured.

In another example, a TCI state according to the QCL relationship may be configured through a higher signal for each LP-SS having each index. Each TCI state may include the following information.

Beam information related to one or multiple SSBs or CSI-RSs, i.e., beam related information (or TCI state) including one or multiple SSB indices or one or more CSI-RS source IDs

### TCI State ID

### One or More Pieces of QCL Information

The QCL information may include a cell ID, a BWP ID, information on one or more multiple reference signals (e.g., CSI-RS ID information when a reference signal is a CSI-RS and SSB index information when the reference signal is an SSB), and information on whether the QCL type is type A, type B, type C, or type D.

In addition to the information such as the ssb-mappingLP-SS, information related to the LP-SS transmission may be configured for the UE through the higher signal. For example, FIG. 7 illustrates that two LP-SSs (LP-SS chunk) in different beam directions, which are QCL-ed with actually transmitted SSBs having two beam directions, respectively, are transmitted. In this case, information on a gap between the LP-SSs having different beam directions may be included in the higher signal in units of OFDM symbol counts and indicated. The period of the LP-SS chunk, the time/frequency position of the LP-SS chunk, and the transmission start position of the LP-SS chunk (which can be indicated in units of radio frames, subframes, slots, or OFDM symbols) may be indicated in the higher signal and indicated to the UE.

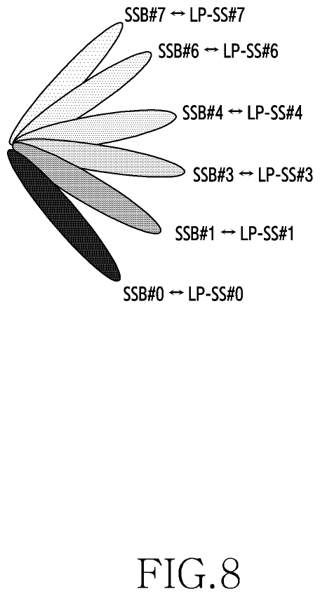

FIG. 8 illustrates a QCL between a WUR-dedicated synchronization signal and a legacy synchronization signal according to an embodiment.

Referring to FIG. 8, another embodiment of defining beam association between an SSB and an LP-SS actually transmitted by a station is provided. Specifically, FIG. 8 teaches a method of configuring information on an LP-SS having beam association with SSBs actually transmitted by the BS and supporting the LP-SS in all beam directions in which the SSBs are transmitted.

Information on the SSB actually transmitted by the BS in the cell may be configured by ssb-PositionInBurst. For example, when a bit field of ssb-PositionInBurst is configured as “11011011”, six SSB bursts (e.g., SSB #0, #1, #3, #4, #6, #7) among a total of eight SSBs within 5 ms may be transmitted. Unlike the method described in FIG. 7, in FIG. 8, a QCL relationship between the actually transmitted SSB and the LP-SS may be defined in the standard without explicit signaling. For example, FIG. 8 illustrates that the SSB and the LP-SS which has the same index have a QCL relationship. Through the method, an SSB having beam association with the LP-SS among the SSBs actually transmitted by the BS may be indicated, and the LP-SS may be transmitted only in the beam direction associated with the actually transmitted SSB. Unlike the method in FIG. 7, in FIG. 8, the actually transmitted SSBs may have LP-SSs that are QCL-ed with the SSBs, respectively.

In FIG. 8, information related to the LP-SS transmission may be configured for the UE through a higher signal. For example, FIG. 8 illustrates that LP-SSs (LP-SS chunk) in different beam directions, which are QCL-ed with actually transmitted SSBs having six beam directions, respectively, are transmitted. In this case, information on a gap between the LP-SSs having different beam directions may be included in the higher signal in units of OFDM symbol counts and indicated. The period of the LP-SS chunk, the time/frequency position of the LP-SS chunk, and the transmission start position of the LP-SS chunk (which can be indicated in units of radio frames, subframes, slots, or OFDM symbols) may be indicated in the higher signal and indicated.

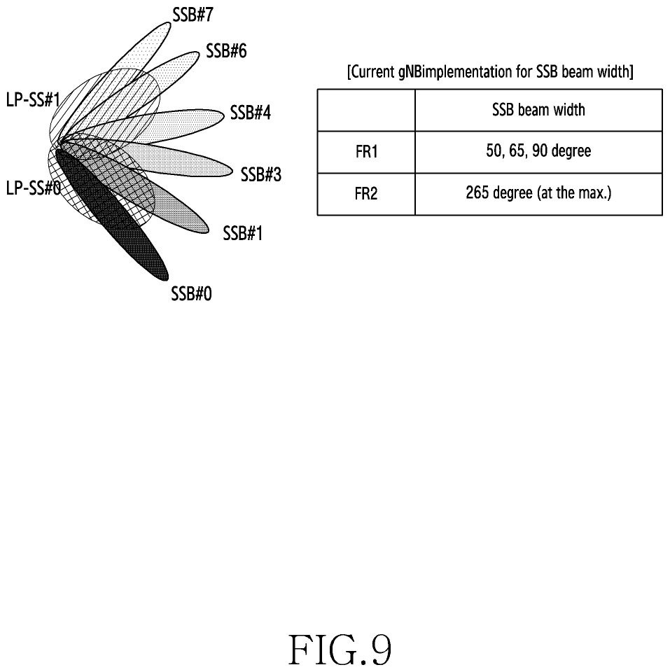

FIG. 9 illustrates a QCL between a WUR-dedicated synchronization signal and a legacy synchronization signal according to an embodiment.

Referring to FIG. 9, another embodiment of defining beam association between an SSB and an LP-SS actually transmitted by a station is shown. Specifically, FIG. 9 teaches a method of minimizing a resource required to transmit an LP-SS by figuring information on an LP-SS having beam association with multiple ally transmitted by the BS, and supporting the LP-SS in all SSB beam directions in which actual transmission is performed.

Information on the SSB actually transmitted by the BS in the cell may be configured by ssb-PositionInBurst. For example, when a bit field of ssb-PositionInBurst is configured as “11011011”, six SSB bursts among a total of eight SSBs within 5 ms may be transmitted.

The BS may configure as many elements as the number of LP-SSs in the beam direction in which the ssb-mappingPerLP-SS corresponding to information for indicating SSBs that are QCL-ed with one LP-SS among the SSBs indicated by the ssb-PositionInBurst is transmitted. That is, when the number of beam directions of the LP-SS is two, two elements included in the ssb-mappingPerLP-SS may be configured. For example, when the BS supports beam directions of two LP-SSs and the ssb-mappingPerLP-SS is configured to have 8-bit information such as the ssb-PositionInBurst for one LP-SS beam direction, in ssb-mappingPerLP-SS={“11010000”, “00001011”}, ssb-mappingPerLP-SS configured as {“11010000”, “00001011”} may indicate that the first SSB (SSB #0), the second SSB (SSB #1), and the third SSB (SSB #3) among the six actually transmitted SSB bursts are QCLed with the first LP-SS (LP-SS #0) and the fourth SSB (SSB #4), the fifth SSB (SSB #6), and the sixth SSB (SSB #7) are QCL-ed with the second LP-SS (LP-SS #1). SSBs having beam association with an LP-SS among the SSBs actually transmitted by the BS may be indicated through a higher signal such as ssb-mappingLP-SS, and the LP-SS in all beam directions in which the SSBs are transmitted may be transmitted.

As another example, when the BS supports beam directions of two LP-SSs and the ssb-mappingPerLP-SS is configured to have 6-bit information such as the number of SSBs actually transmitted in the ssb-PositionInBurst for one LP-SS beam direction, in ssb-mappingPerLP-SS={“111000”, “000111”}, ssb-mappingPerLP-SS configured as {“111000”, “000111”} may indicate that the first SSB (SSB #0), the second SSB (SSB #1), and the third SSB (SSB #3) among the six actually transmitted SSB bursts are QCLed with the first LP-SS (LP-SS #0) and the fourth SSB (SSB #4), the fifth SSB (SSB #6), and the sixth SSB (SSB #7) are QCL-ed with the second LP-SS (LP-SS #1). The BS may indicate, to the UE, SSBs having beam association with an LP-SS among the SSBs actually transmitted by the BS through a higher signal such as ssb-mappingLP-SS, and the LP-SS in all beam directions in which the SSBs are transmitted may be transmitted.

In another example, the BS may support beam directions of two (generalized to N) LP-SSs and may configure, for the UE, the number (generalized to K) of SSBs that are in the QCL relationship with the LP-SS in an order of the index of the SSB actually transmitted in the ssb-PositionInBurst for one LP-SS beam direction. In this case, when the BS configures, for the UE, that each LP-SS is QCL-ed with three SSBs among the actually transmitted six SSB bursts, without a higher signal such as the ssb-mappingPerLP-SS, it may be configured that the first, second, and third SSBs are QCL-ed with the first LP-SS (the LP-SS having the 0^{th} index) and the fourth, fifth, and sixth SSBs are QCL-ed with the second QCL-ed LP-SS (the LP-SS having the first index). According to the method, information configured in the form such as {N, K} may be configured for the UE, and in this case, the UE may interpret that the BS support N LP-SS beam directions and K SSBs are in the QCL relationship with one LP-SS beam direction in the order of the index of the actually transmitted SSB. In this case, when the number of the actually transmitted SSBs is L, the UE may not expect that the value of L is smaller than K. The UE may expect that L=N*K is always satisfied. Alternatively, the UE may expect that L=N*K is not always satisfied, and may expect that (N−1)*K<L is at least always satisfied. When (N−1)*K<L<N*K, the UE may assume that LP-SSs corresponding to the first to (N−1)^{th} LP-SSs are QCL-ed with K SSBs in the order of the indices of the SSBs, and may expect that the N^{th} LP-SS is QCL-ed with (L−(N−1)*K) SSBs to which the largest index is assigned among L SSBs that are actually transmitted.

In another example, a TCI state according to the QCL relationship may be configured through a higher signal for each LP-SS having each index. Each TCI state may include the following information.

Beam information related to one or multiple SSBs or CSI-RSs, i.e., beam related information (or TCI state) including one or multiple SSB indices or one or more CSI-RS source IDs

### TCI State ID

### One or More Pieces of QCL Information

The QCL information may include a cell ID, a BWP ID, information on one or more multiple reference signals (e.g., CSI-RS ID information when a reference signal is a CSI-RS and SSB index information when the reference signal is an SSB), and information on whether the QCL type is type A, type B, type C, or type D.

When multiple SSBs are QCL-ed with one LP-SS, the LP-SS needs to be transmitted in a wider range of spatial region than the SSBs, but the coverage may be reduced. To solve the issue of the coverage being reduced, a value for transmission power of the LP-SS may be configured through a higher signal compared to transmission power of the SSB. That is, when the transmission power of the SSB is configured as 1, a value such as LP-SSpowerToSSB for configuring LP-SS transmission power may be configured for the UE.

FIG. 9 illustrates that multiple SSBs are QCL-ed with one LP-SS, and all the embodiments above describe an example in which multiple SSBs are QCL-ed with one LP-SS, but the same method is applicable to a case where one SSB is QCL-ed with multiple LP-SSs.

In addition to the information such as the ssb-mappingLP-SS, information related to the LP-SS transmission may be configured for the UE through the higher signal. For example, FIG. 9 illustrates that LP-SSs (LP-SS chunk) in different beam directions, which are QCL-ed with actually transmitted multiple SSBs having six beam directions are transmitted, and in this case, information on a gap between the LP-SSs having different beam directions may be included in the higher signal in units of OFDM symbol counts and indicated. The period of the LP-SS chunk, the time/frequency position of the LP-SS chunk, and the transmission start position of the LP-SS chunk (which can be indicated in units of radio frames, subframes, slots, or OFDM symbols) may be indicated in the higher signal and indicated to the UE.

Hereinafter, according to various embodiments of the disclosure, a procedure of waking up a main radio when the main radio of a UE is in a sleep state is described. According to an embodiment, an operation of waking up the main radio may be performed in combination with at least one of various operations according to various embodiments in FIGS. 1 to 9 in the disclosure, or may be separately performed, and may not be essential.

According to an embodiment of the disclosure, when there is a channel or a signal to be transmitted to the UE, a BS may transmit a WUS to the UE. The UE or a WUR may receive the WUS to turn on the main radio. The operation of receiving the WUS by the UE may be an indication to wake up the main radio. The WUS may include K information bits, and information indicating to wake up the main radio may be mapped to the K information bits. For example, when an information bit included in the WUS is 1-bit information, “1” may indicate “ON” and “0” may indicate “OFF”. Alternatively, conversely, “0” may indicate “ON” and “1” may indicate “OFF”.

In the perspective of transmission by the BS, a time point before transmission of a channel of a signal, at which the WUS is to be transmitted, may be pre-defined. In the perspective of reception by the UE, a time point before reception of a channel or a signal, at which the WUS can be received, may be pre-defined. Alternatively, in the perspective of reception by the UE, a time point before reception of a channel or a signal, at which the WUS can be received, may be configured for the UE through signaling.

The UE may transmit information on a time offset required between transmissions of the WUS and the channel/signal to the BS, and the BS may configure, for the UE, a time offset required between transmissions of the WUS and the channel/signal, based on the received information. This time offset may indicate a time interval required for the UE to receive the WUS and receive the channel/signal transmitted from the BS. The UE may transmit information on the time offset required between transmissions of the WUS and the channel/signal to the BS through UE capacity information report procedure, or may transmit the same through an UL data channel or an RA preamble in an RA procedure. However, the disclosure is not limited thereto, and the UE may transmit the information on the time offset to the BS through higher-layer signaling information, and/or transmit the same through various signals and/or a combination of the various signals.

The BS may configure the information on the time offset between transmissions of the WUS and the channel/signal for the UE through a DL data channel of an RAR (e.g., message 2) or RA contention resolution (e.g., message 4) in the RA procedure. However, the disclosure is not limited thereto, and the BS may configure the information on the time offset for the UE through higher-layer signaling information, and/or configure the same through various signals and/or a combination of the various signals.

When there is a periodic channel or a periodic signal to be transmitted to the UE by the BS, the UE or the WUR may turn on the main radio according to a period based on configuration information of the periodic channel or the periodic signal configured by the BS, instead the BS transmits the WUS whenever there is a channel or a signal to be transmitted. According to an embodiment of the disclosure, the period information itself of the periodic channel or the periodic signal may be included in the WUS and transmitted.

The BS may transmit the WUS only in the first transmission of the periodic channel or the periodic signal, and may omit the transmission of the WUS in repeated transmissions of the channel or signal thereafter. In this case, the UE or the WUR may turn on the main radio, based on the period according to the configuration information of the periodic channel or the periodic signal configured by the BS.

The type of the periodic channel or the periodic signal transmitted and received by the BS and the UE may be pre-defined. The type of the periodic channel or the periodic signal may be configured by the BS. For example, the BS may configure the type of the periodic channel or the periodic signal for the UE through a DL data channel of an RAR (e.g., message 2) or RA contention resolution (e.g., message 4), or may configure the configuration information for the reception of the WUS for the UE through higher-layer signaling information and/or L1 signaling information.

When there is a channel or a signal (e.g., a physical RA channel (PRACH), a scheduling request (SR), or a buffer status report (BSR)) to be transmitted to the BS by the UE or when the UE performs L1/L3-based measurement, the UE or the WUR may turn on the main radio regardless of the WUS transmitted by the BS.

For the UL transmission or L1/L3-based measurement transmitted to the BS by the UE, the WUR may receive the WUS but may not apply the operation of turning on or off the main radio. That is, in this case, even when the WUS is not received, the WUR of the UE may have already turned on the main radio by configuration of a higher layer by the BS, the UE (or the main radio) may have been already in the ON state, and in this case, the UE (or the main radio) in the ON state may not be turned on by the WUS. This configuration may be at least one of configuration of reception and transmission and a resource related to the UL or L1/L3-based measurement, and configuration of whether to turn on or off the main radio by the UL or L1/L3-based measurement configuration regardless of whether the WUS is received.

The L1/layer 3 (L3)-based measurement or the type of an UL channel or an UL signal of the UE, transmitted regardless of the operation of receiving the WUS, may be pre-defined. The L1/L3-based measurement or the type of the UL channel or the UL signal may be configured by the BS. For example, the BS may configure the L1/L3-based measurement or the type of the UL channel or the UL signal for the UE through a DL data channel of an RAR (e.g., message 2) or RA contention resolution (e.g., message 4), or may configure the L1/L3-based measurement or the type of the UL channel or the UL signal for the UE through L1 signaling information and/or higher-layer signaling information indicating configuration information for reception of the WUS.

Hereinafter, according to an embodiment of the disclosure, an operation of turning off a main radio when the main radio is in an ON state is described. According to an embodiment, when the main radio is in the ON state, the operation of turning off the main radio may be performed in combination with at least one of various operations according to various embodiments in FIGS. 1 to 8 in the disclosure, or may be performed separately, and may not be essential.

A BS may transmit a sleep signal to a UE when there is no channel or signal to be transmitted to the UE. The UE or a WUR may receive the sleep signal and turn off the main radio. The operation itself of receiving the sleep signal by the UE may be an indication to put the main radio to sleep (or turn off the main radio). The sleep signal may be configured as a separate sequence from the WUS. The sleep signal may include information to which information indicating to put the main radio to sleep from the K information bits included in the WUS is mapped. For example, in 1-bit information, “0” may indicate “OFF”, and “1” may indicate “ON”. For example, in 1-bit information, “1” may indicate “OFF”, and “0” may indicate “ON”. That is, when the information bit included in a specific signal indicates “OFF”, the specific signal may be interpreted as a sleep signal, and when the specific signal indicates “ON”, the specific signal may be interpreted as a WUS. That is, the sleep signal and the WUS may be distinguished from each other according to an information bit value in the same signal.

The main radio of the UE may be turned off when a configured condition is satisfied. For example, the condition (the condition in which the main radio is off) configured for the main radio may be a case where the main radio fails to detect or decode a down control channel or a specific channel or signal during the configured interval. The BS may configure configuration information for determining whether to turn off the main radio (e.g., information including an interval and a specific channel or signal) for the UE through higher-layer signaling information and/or L1 signaling information indicating configuration information for reception of the WUS.

The main radio of the UE may be always turned off after receiving a channel or signal. The WUR may receive the WUS from the BS to turn on the main radio, and the main radio may receive the channel or signal and then the main radio may turned off. A time required for the main radio to be turned off after completion of the reception of the channel or signal may be pre-defined. The UE may transmit information on the time required for the main radio to be turned off to the BS, and the BS may configure the required time to the UE, based on the received information. The information on the required time transmitted by the UE may be transmitted to the BS through a UE capability information reporting procedure. The information on the required time transmitted by the UE may be transmitted to the BS through a RA preamble or an UL data channel. However, the disclosure is not limited thereto, and the UE may transmit the information on the required time to the BS through higher-layer signaling information. The BS may configure the information on the required time transmitted by the UE for the UE through a DL data channel of an RAR (e.g., message 2) or RA contention resolution (e.g., message 4). However, the disclosure is not limited thereto, and the BS may configure the information on the required time for the UE by higher-layer signaling information.

When the UE or the main radio of the UE is in an RRC_CONNECTED state, connected mode DRX (C-DRX) may be configured, and the main radio may wake up and perform PDCCH reception in each DRX cycle. When the UE or the main radio of the UE is in the RRC_CONNECTED state, the UE (or the main radio) may be configured to receive a signal indicating whether the UE needs to receive a PDCCH in the next DRX cycle.

When the main radio is in an RRC_IDLE/RRC_INACTIVE state, idle mode DRX (I-DRX) may be configured for the UE, and the main radio may wake up and receive a paging PDCCH in each paging cycle. When the UE or the main radio of the UE is in the RRC_CONNECTED state, the UE (or the main radio) may be configured to receive a signal indicating whether to receive a paging PDCCH in the next paging cycle to the UE.

Hereinafter, a procedure of a UE operating as a WUR when an operation in which “ON/OFF” of the main radio is indicated based on reception of the WUS and the WUR and an operation according to the configuration of C-DRX or I-DRX are mixed is described. The operation of the UE or the main radio of the UE, related to the RRC CONNECTED/IDLE/INACTIVE state, may be performed in combination with at least one various operations according to an embodiment in FIGS. 1 to 9 in the disclosure, or may be performed separately, and may not be essential.

When the UE having the WUR receives the WUS and performs the operation of turning on or off the main radio of the UE, the UE may not perform configuration of C-DRX or I-DRX and the operation according to the configuration. In this case, instead of performing the configuration of C-DRX or I-DRX and the operation according to the configuration, when the UE may turn on the main radio of the UE only when the WUS indicating to wake up the main radio is received, and when the main radio of the UE is in the ON state, the main radio receive a PDCCH and a PDSCH defined or configured to be received in C-DRX or I-DRX.

When the UE or the main radio of the UE is int the RRC_CONNECTED state and the operation performed by the WUR is configured or activated by the BS, the UE may turn on the main radio when the WUR receives the WUS indicating to wake up the main radio. In addition, when the main radio is turned on, the UE may perform an operation (e.g., an operation in which the main radio receives a PDCCH within drx_onDurationTimer in each DRX cycle) related to C-DRX configured from the BS. The UE (or the main radio) may not perform the operation configured to receive a signal (e.g., DCI format 2_6 or WUS) indicating whether to receive the PDCCH in the next DRX cycle to the UE.

When the UE or the main radio of the UE is in the RRC_IDLE/INACTIVE state and the operation performed by the WUR is configured or activated by the BS, the UE may turn on the main radio when the WUR receives the WUS indicating to wake up the main radio. The UE may perform an operation (e.g., an operation in which the main radio wakes up and receives a paging PDCCH in each paging cycle) related to I-DRX configured by the BS. The UE (or the main radio) may not perform the operation configured to receive a signal (e.g., DCI format 2_7 or paging early indication) indicating whether to receive the paging PDCCH in the next paging cycle to the UE.

Instead of performing the operation according to the configuration related to C-DRX or I-DRX, the UE may perform an operation of waking up the main radio and an operation of turning off the main radio according to the WUR and the WUS according to an embodiment. When the operation performed by the WUR is deactivated by the BS, operations related to C-DRX or I-DRX configured by the BS may be performed again. That is, a priority of the operation based on the WUS corresponding to the WUR may be higher than a priority according to DRX configuration. In other words, when the operation performed by the WUR and the operations related to C-DRX or I-DRX are all configured/activated for the UE, the UE may perform only the operation performed by the WUR, and may not perform the operations related to C-DRX or I-DRX.

When the operation performed by the WUR of the UE is configured or activated by the

BS, the UE or the WUR receives the WUS, and the main radio is turned on, the UE may transition to the RRC_CONNECTED state or may transition to the RRC_IDLE or RRC_INACTIVE state. The state to which the UE may transition may be predetermined, or may be determined by higher-layer signaling information and/or L1 signaling information for the WUR operation configuration by the BS.

As an example in which information on the transition of the UE is predetermined, the state of the main radio may follow the state immediately before the main radio is turned off most recently after being turned on just prior to a current time in which the main radio is turned on. As another example in which information on the transition of the UE is predetermined, the state of the main radio may not be affected by whether the WUR operation is configured and activated. For example, the state of the main radio of the UE may be determined only by higher-layer signaling information indicating at least one of RRC_CONNECTED, RRC_IDLE, or RRC_INACTIVE, and the UE may determine that the state of the main radio is not changed by whether the WUR operation is configured and activated.

The WUS may include K information bits, and information on at least one of whether the main radio transitions to the RRC_CONNECTED state, whether the main radio transitions to the RRC_IDLE state, or whether the main radio transitions to the RRC_INACTIVE may be mapped to the K information bits.

When the UE or the main radio of the UE is in the RRC_CONNECTED state based on the determined state of the UE, the main radio may wake up and receive a PDCCH at each DRX cycle by the C-DRX configured by the BS, or the UE (or the main radio) may be configured from the BS to receive the signal indicating whether to receive the PDCCH in the next DRX cycle to the UE. When the operation for turning off the main radio according to various embodiments while the UE is receiving the PDCCH (for example, in an interval in which the PDCCH is received), the UE may prioritize to perform the procedure for turning off the main radio.

When the UE or the main radio of the UE is in the RRC_IDLE/INACTIVE state, the main radio may wake up and receive a paging PDCCH in each paging cycle by I-DRX configured by the BS. The UE (or the main radio) may be configured from the BS to receive a signal indicating whether to receive a paging PDCCH in the next paging cycle to the UE. When the operation for turning off the main radio according to various embodiments while the UE is receiving the paging PDCCH (for example, in an interval in which the paging PDCCH is received), the UE may prioritize to perform the procedure for turning off the main radio.

According to various embodiments of the disclosure, the above-described various operations of the UE (or the main radio or the WUR) may be performed regardless of the sequence, and as an entity for performing the operation, the UE, the main radio, or the WUR may be interchangeably used.

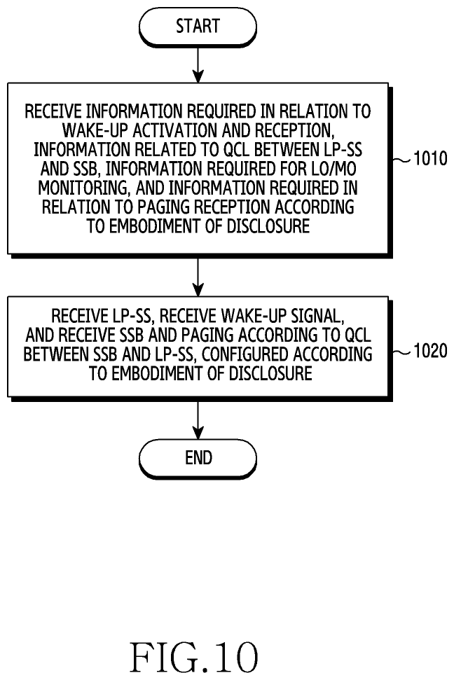

FIG. 10 illustrates a method of a UE according to an embodiment.

Referring to FIG. 10, in step 1010, a UE may receive a wake-up activation signal or a wake-up deactivation signal. The UE may receive a wake-up activation signal from a BS to receive a WUS by using a WUR, or may receive a wake-up deactivation signal so that the WUS is no longer received using the WUR from the BS. The UE may receive information required for reception of the WUS from the baes station.

The UE may receive information required in relation to QCL between an LP-SS and an SSB from the BS.

The UE may receive information required for LO and MO monitoring included in the LO from the BS. The UE may receive a signal indicating configuration information for reception of the WUS or whether to use the WUR from the BS. In addition, the UE may receive information required to receive paging from the BS.

In step 1020, the UE may receive an LP-SS according to the configured QCL between the SSB and the LP-SS, receive the WUS, and receive the SSB and paging. In an embodiment, when the WUR of the UE is configured or activated and is turned on to search for a WUS and the WUR receives the WUS, the UE may receive paging in the PF (paging frame)/PO (paging occasion) determined according to an embodiment. When the WUR is not configured or is not activated, the UE may receive paging in the PF/PO determined based on a paging reception scheme for a legacy UE.

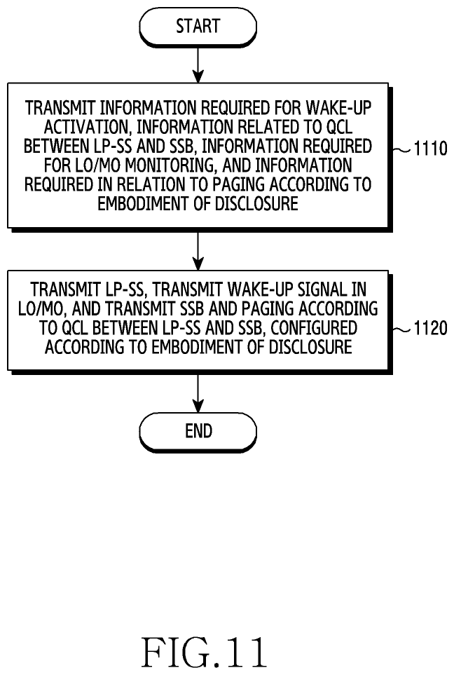

FIG. 11 illustrates a method of a BS according to an embodiment.

Referring to FIG. 11, in step 1110, a BS may transmit a wake-up activation signal or a wake-up deactivation signal to a UE. The BS may transmit a wake-up activation signal to the UE so that the UE receives a WUS by using a WUR, or may transmit a wake-up deactivation signal to the UE so that the UE does not receive the WUS any longer by using the WUR. The BS may transmit information required in relation to QCL between an LP-SS and an SSB to the UE. In addition, information required for reception of the WUS may be transmitted to the UE. According to an embodiment, information required for LO and MO monitoring included in the LO may be received from the BS. In an embodiment, the BS may transmit a signal indicating configuration information for reception of the WUS or whether to use the WUR to the UE. The BS may transmit information required to receive paging to the UE.

In step 1120, the BS may transmit an LP-SS according to the QCL between the SSB and the LP-SS, configured according to the above-described embodiment, transmit the WUS, and transmit the SSB and paging. When the WUR of the UE is configured or activated and is turned on to search for a WUS, the BS transmits the WUS, and the UE receives the WUS, the BS may transmit paging in the PF/PO determined according to an embodiment. When the WUR is not configured or is not activated, the BS may transmit paging in the PF/PO determined based on a paging reception scheme for a legacy UE.

A method of a UE in a wireless communication system according to the disclosure may include receiving information related to monitoring of a WUS from a BS, determining, based on the information, an occasion in which the WUS is transmitted, and receiving, based on the occasion, the WUS from the BS.

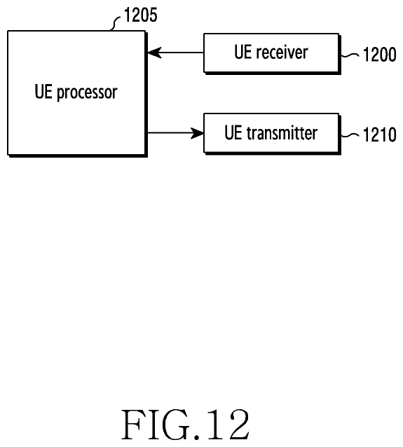

FIG. 12 illustrates a structure of a UE according to an embodiment.

Referring to FIG. 12, the UE may include a UE receiver 1200, a UE transmitter 1210, and a UE processor (controller) 1205.

The UE receiver 1200 and the UE transmitter 1210 as a whole may be referred to as a transceiver. The UE receiver 1200, the UE transmitter 1210, and the UE processor 1205 of the

UE may operate according to the communication method of the UE as described above. Components of the UE are not limited to the above-described example. For example, the UE may include more components (e.g., a memory, etc.) or fewer components compared to the aforementioned components. The UE receiver 1200, the UE transmitter 1210, and the UE processor 1205 may be implemented in the form of a single chip.

The UE receiver 1200 and the UE transmitter 1210 (or transceiver) may transmit/receive signals to/from BSs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

The transceiver may receive signals through a radio channel, output the same to the UE processor 1205, and transmit signals output from the UE processor 1205 through the radio channel.

A memory may store a program and data necessary for operations of the UE. The memory may store control information or data included in a signal acquired by the UE. The memory may include storage media such as a read only memory (ROM), a random access memory (RAM), a hard disk, a CD-ROM, and a digital versatile disc (DVD), or a combination of storage media.

The UE processor 1205 may control a series of procedures so that the UE can operate according to the aforementioned embodiments of the disclosure. The UE processor 1205 may be implemented by a controller or one or more processors.

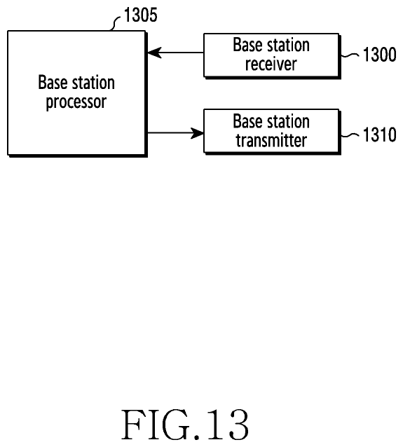

FIG. 13 illustrates a structure of a BS according to an embodiment.

Referring to FIG. 13, the BS may include a BS receiver 1300, a BS transmitter 1310, and a BS processor (controller) 1305.

The BS receiver 1300 and the BS transmitter 1310 as a whole may be referred to as a transceiver. The BS receiver 1300, the BS transmitter 1310, and the BS processor 1305 of the BS may operate according to the communication method of the BS as described above.

However, components of the BS are not limited to the above-described example. For example, the BS may include more components (e.g., a memory, etc.) or fewer components compared to the aforementioned components. The BS receiver 1300, the BS transmitter 1310, and the BS processor 1305 may be implemented in the form of a single chip.

The BS receiver 1300 and the BS transmitter 1310 (or transceiver) may transmit/receive signals to/from UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

The transceiver may receive signals through a radio channel, output the same to the BS processor 1305, and transmit signals output from the BS processor 1305 through the radio channel.

A memory (not illustrated) may store a program and data necessary for operations of the BS. The memory may store control information or data included in a signal acquired by the BS. The memory may include storage media such as a ROM, a RAM, a hard disk, a CD-ROM, and a DVD, or a combination of storage media.

The BS processor 1305 may control a series of processes such that the BS can operate according to the above-described embodiments of the disclosure. The BS processor 1305 may be implemented by a controller or one or more processors.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Blocks in the respective flow diagrams and combinations of flowcharts should be understood as being executed by one or more computer programs including computer-executable instructions. The one or more computer programs may be all stored in a single memory, or may be separately stored in multiple different memories.

All the functions or operations set forth herein may be processed by a single processor or a combination of processors. The single processor or combination of processors is circuitry for performing processing, and may include circuitry devices such as an application processor (AP), a communication processor (CP), a graphical processing unit (GPU), a neural processing unit (NPU), a microprocessor unit (MPU), a system on chip (SoC), and an integrated chip (IC).

The processor may include various processing circuits and/or multiple processors. For example, as used herein and the claims, the term “processor” may include various processing circuits including at least one processor. One or more of the at least one processor may be configured to individually and/or collectively perform the functions set forth herein in a distributed manner. As used herein, “a processor”, “at least one processor”, or “one or more processors” may be configured to perform various functions. However, these terms cover, without any limitation, situations where one processor performs some of the functions and any other processor(s) perform(s) the other functions and situations where a single processor may perform all the functions. Also, the at least one processor may include a combination of processors that perform various functions among the functions set forth herein in a distributed manner. The at least one processor may execute instructions to implement or perform various functions.

Each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been described with reference to various embodiments, various changes may be made without departing from the spirit and the scope of the disclosure, which is defined, not by the detailed description and embodiments, but by the appended claims and their equivalents.

What is claimed is:

1. A method performed by a user equipment (UE) in a wireless communication system, the method comprising:
receiving, from a base station (BS), configuration information for receiving a low-power synchronization signal (LP-SS);
identifying a relation of quasi co-location (QCL) between the LP-SS and synchronization signal blocks (SSB) s based on the configuration information, wherein the SSBs are indicated by a field of SSB-PositionInBurst in a system information block 1 (SIB1); and
receiving, from the BS, the LP-SS based on the identified relation of the QCL.

2. The method of claim 1, wherein, in case that a subset of the SSBs quasi co-located with the LPSS is indicated by the configuration information, the LP-SS is received based on the QCL of the subset of SSBs.

3. The method of claim 2, wherein, in case that a subset of the SSB is not indicated by the configuration information, the LP-SS is received based on the QCL of the SSBs indicated by the field of SSB-PositionInBurst in the SIB1,
wherein each of the SSBs is quasi co-located with the LPSS.

4. The method of claim 1, wherein the configuration information further includes information on a start symbol of the LP-SS relative to a system frame number 0 (SFN0), and a transmission period of the LP-SS.

5. The method of claim 1, wherein the configuration information further includes information on a type of the QCL,
wherein the type of the QCL is type C or type D.

6. A method performed by a base station (BS) in a wireless communication system, the method comprising:
transmitting, to a user equipment (UE), configuration information for receiving a low-power synchronization signal (LP-SS); and
transmitting, to the UE, the LP-SS based on a relation of quasi co-location (QCL) between the LP-SS and synchronization signal blocks (SSB) s, wherein the SSBs are indicated by a field of SSB-PositionInBurst in a system information block 1 (SIB1).

7. The method of claim 6, wherein, in case that a subset of the SSBs quasi co-located with the LPSS is indicated by the configuration information, the LP-SS is transmitted based on the QCL of the subset of SSBs.

8. The method of claim 7, wherein, in case that a subset of the SSB is not indicated by the configuration information, the LP-SS is transmitted based on the QCL of the SSBs indicated by the field of SSB-PositionInBurst in the SIB1,
wherein each of the SSBs is quasi co-located with the LPSS.

9. The method of claim 6, wherein the configuration information further includes information on a start symbol of the LP-SS relative to a system frame number 0 (SFN0), and a transmission period of the LP-SS.

10. The method of claim 6, wherein the configuration information further includes information on a type of the QCL,
wherein the type of the QCL is type C or type D.

11. A user equipment (UE) comprising:
a transceiver; and
a processor coupled to the transceiver and configured to:
receive, from a base station (BS), configuration information for receiving a low-power synchronization signal (LP-SS);
identify a relation of quasi co-location (QCL) between the LP-SS and synchronization signal blocks (SSB) s based on the configuration information, wherein the SSBs are indicated by a field of SSB-PositionInBurst in a system information block 1 (SIB1); and
receive, from the BS, the LP-SS based on the identified relation of the QCL.

12. The UE of claim 11, wherein, in case that a subset of the SSBs quasi co-located with the LPSS is indicated by the configuration information, the LP-SS is received based on the QCL of the subset of SSBs.

13. The UE of claim 12, wherein, in case that a subset of the SSB is not indicated by the configuration information, the LP-SS is received based on the QCL of the SSBs indicated by the field of SSB-PositionInBurst in the SIB1,
wherein each of the SSBs is quasi co-located with the LPSS.

14. The UE of claim 11, wherein the configuration information further includes information on a start symbol of the LP-SS relative to a system frame number 0 (SFN0), and a transmission period of the LP-SS.

15. The UE of claim 11, wherein the configuration information further includes information on a type of the QCL,
wherein the type of the QCL is type C or type D.

16. A base station (BS) comprising:
a transceiver; and
a processor coupled to the transceiver and configured to:
transmit, to a user equipment (UE), configuration information for receiving a low-power synchronization signal (LP-SS); and
transmit, to the UE, the LP-SS based on a relation of quasi co-location (QCL) between the LP-SS and synchronization signal blocks (SSB) s, wherein the SSBs are indicated by a field of SSB-PositionInBurst in a system information block 1 (SIB1).

17. The BS of claim 16, wherein, in case that a subset of the SSBs quasi co-located with the LPSS is indicated by the configuration information, the LP-SS is transmitted based on the QCL of the subset of SSBs.

18. The BS of claim 17, wherein, in case that a subset of the SSB is not indicated by the configuration information, the LP-SS is transmitted based on the QCL of the SSBs indicated by the field of SSB-PositionInBurst in the SIB1,
wherein each of the SSBs is quasi co-located with the LPSS.

19. The BS of claim 16, wherein the configuration information further includes information on a start symbol of the LP-SS relative to a system frame number 0 (SFN0), and a transmission period of the LP-SS.

20. The BS of claim 16, wherein the configuration information further includes information on a type of the QCL,
wherein the type of the QCL is type C or type D.
